(19) United States
(12) Patent Application Publication
(10) Pub. No.: US 2020/0254845 A1
(43) Pub. Date: Aug. 13, 2020

(54) EQUIPMENT COOLING DEVICE

(71) Applicant: DENSO CORPORATION, Kariya-city (JP)

(72) Inventors: Koji MIURA, Kariya-city (JP); Yasumitsu OMI, Kariya-city (JP); Takeshi YOSHINORI, Kariya-city (JP); Masayuki TAKEUCHI, Kariya-city (JP)

(21) Appl. No.: 16/861,044

(22) Filed: Apr. 28, 2020

Related U.S. Application Data
(63) Continuation of application No. PCT/JP2018/035985, filed on Sep. 27, 2018.

(30) Foreign Application Priority Data
Nov. 1, 2017 (JP) 2017-211970

(51) Int. Cl. B60H 1/00; H01M 10/613; H01M 10/625; H01M 10/6556; H01M 10/6568; H01M 10/635; H01M 10/6561

(52) U.S. Cl. CPC B60H 1/00278; H01M 10/613; H01M 10/625; H01M 2220/20; H01M 10/6568; H01M 10/635; H01M 10/6561; H01M 10/6556

(57) ABSTRACT

A cooler cools a target equipment by evaporation latent heat of working fluid. A cold-heat heat exchanger condenses the working fluid by radiating heat of the working fluid using cold heat of low-temperature and low-pressure refrigerant circulating in a refrigeration cycle. An air-cooled heat exchanger condenses the working fluid by radiating heat of the working fluid using cold heat of outside air. The cooler, the cold-heat heat exchanger, and the air-cooled heat exchanger are connected by a gas pipe and a liquid pipe. An outside air temperature detector detects an outside air temperature. A saturation temperature detector detects a saturation temperature of the working fluid circulating in a thermosiphon circuit. A heat radiation controller controls an amount of heat radiated from the working fluid flowing through the cold-heat heat exchanger so that the saturation temperature of the working fluid becomes higher than the outside air temperature.

### CROSS REFERENCE TO RELATED APPLICATIONS

The present application is a continuation application of International Patent Application No. PCT/JP2018/035985 filed on Sep. 27, 2018, which designated the U.S. and claims the benefit of priority from Japanese Patent Application No. 2017-211970 filed on Nov. 1, 2017. The entire disclosures of all of the above applications are incorporated herein by reference.

### TECHNICAL FIELD

The present disclosure relates to an equipment cooling device that cools a target equipment by a thermosiphon circuit.

### BACKGROUND

An equipment cooling device is known, which cools a target equipment by a loop thermosiphon circuit. The thermosiphon circuit cools the target equipment by the phase change of working fluid.

### SUMMARY

According to one aspect of the present disclosure, an equipment cooling device that cools a target equipment by a thermosiphon circuit that uses cold heat of a refrigeration cycle and cold heat of outside air includes:

a cooler configured to cool the target equipment by latent heat of vaporization of the working fluid;

a cold-heat heat exchanger that radiates heat of the working fluid evaporated by the cooler by utilizing the cold heat of the low-temperature and low-pressure refrigerant circulating in the refrigeration cycle to condense the working fluid;

an air-cooled heat exchanger that radiates heat of the working fluid evaporated by the cooler by utilizing the cold heat of the outside air to condense the working fluid;

a gas pipe to guide the refrigerant evaporated in the cooler to the cold-heat heat exchanger and the air-cooled heat exchanger;

a liquid pipe to guide the refrigerant condensed by the cold-heat heat exchanger and the air-cooled heat exchanger to the cooler;

an outside air temperature detector to detect an outside air temperature;

a saturation temperature detector to detect a saturation temperature of the working fluid circulating through a thermosiphon circuit including the cooler, the cold-heat heat exchanger, the air-cooled heat exchanger, the gas pipe and the liquid pipe; and

a heat radiation controller that adjusts a heat radiation amount of the working fluid flowing through the cold-heat heat exchanger so that the saturation temperature of the working fluid is higher than the outside air temperature.

### BRIEF DESCRIPTION OF THE DRAWINGS

FIG. 1 is a schematic configuration diagram of an equipment cooling device according to a first embodiment.

FIG. 2 is a schematic configuration diagram of a cooler and a battery pack to be cooled by the cooler in the equipment cooling device according to the first embodiment.

FIG. 3 is a cross-sectional view of the cooler and the like in the equipment cooling device according to the first embodiment.

FIG. 4 is a flowchart illustrating a control process executed by a controller according to the first embodiment.

FIG. 5 is a diagram illustrating heat transfer among a cooler, a cold-heat heat exchanger, and an air-cooled heat exchanger in an equipment cooling device of a comparative example.

FIG. 6 is a diagram illustrating heat transfer among the cooler, a cold-heat heat exchanger, and an air-cooled heat exchanger in the equipment cooling device according to the first embodiment.

FIG. 7 is a flowchart illustrating a control process executed by a controller according to a second embodiment.

FIG. 8 is a graph illustrating a relationship between a degree of superheat of refrigerant and a cooling capacity of an evaporator in a refrigeration cycle.

FIG. 9 is a flowchart illustrating a control process executed by a controller according to a third embodiment.

FIG. 10 is a schematic configuration diagram of an equipment cooling device according to a fourth embodiment.

FIG. 11 is a flowchart illustrating a control process executed by a controller according to the fourth embodiment.

FIG. 12 is a schematic configuration diagram of an equipment cooling device according to a fifth embodiment.

FIG. 13 is a flowchart illustrating a control process executed by a controller according to the fifth embodiment.

FIG. 14 is a schematic configuration diagram of an equipment cooling device according to a sixth embodiment.

FIG. 15 is a flowchart illustrating a control process executed by a controller according to the sixth embodiment.

FIG. 16 is a schematic configuration diagram of an equipment cooling device according to a seventh embodiment.

FIG. 17 is a flowchart illustrating a control process executed by a controller according to the seventh embodiment.

FIG. 18 is a schematic configuration diagram of an equipment cooling device according to an eighth embodiment.

FIG. 19 is a flowchart illustrating a control process executed by a controller according to the eighth embodiment.

FIG. 20 is a flowchart illustrating a control process executed by the controller according to a ninth embodiment;

FIG. 21 is a schematic configuration diagram of an equipment cooling device according to a tenth embodiment.

FIG. 22 is a schematic configuration diagram of an equipment cooling device according to an eleventh embodiment.

FIG. 23 is a determination diagram illustrating a control process executed by a controller according to a twelfth embodiment.

FIG. 24 is a diagram illustrating heat transfer among a cooler, a cold-heat heat exchanger, and an air-cooled heat exchanger in an equipment cooling device according to a thirteenth embodiment.

FIG. 25 is a flowchart illustrating a control process executed by a controller according to the thirteenth embodiment.

FIG. 26 is a flowchart illustrating a control process executed by a controller according to a fourteenth embodiment.

FIG. 27 is a diagram illustrating heat transfer among a cooler, a cold-heat heat exchanger, and an air-cooled heat exchanger in an equipment cooling device according to a fifteenth embodiment.

FIG. 28 is a flowchart illustrating a control process executed by a controller according to the fifteenth embodiment.

### DETAILED DESCRIPTION

To begin with, examples of relevant techniques will be described.

An equipment cooling device cools a target equipment by a loop thermosiphon circuit provided in a cooling device. The thermosiphon circuit connects a cooler that exchanges heat between a target equipment and a working fluid with two condensers that condense the working fluid evaporated by the cooler by piping. One of the two condensers is an air-cooled heat exchanger that exchanges heat between outside air and the working fluid. The other condenser is a cold-heat heat exchanger that exchanges heat between a low-temperature and low-pressure refrigerant circulating in a refrigeration cycle and the working fluid. The working fluid absorbs heat from the target equipment in the cooler to evaporate, and radiates heat to the outside air and the refrigerant in the air-cooled heat exchanger and the cold-heat heat exchanger, respectively, to condense. The working fluid flows into the cooler again due to the self-weight as liquid. Thus, the thermosiphon circuit provided in the cooling device cools the target equipment by the phase change of the working fluid using the cold energy of the outside air and the cold energy of the refrigeration cycle.

The cooling device drives a compressor that forms a refrigeration cycle when the temperature of the cooler is higher than a predetermined set temperature, and gradually increases the rotation speed of the compressor. When the temperature of the cooler is lower than a predetermined set temperature, the cooling device stops driving of the compressor of the refrigeration cycle.

However, in the cooling device, when the rotation speed of the compressor that forms the refrigeration cycle is increased, if the saturation temperature of the working fluid circulating in the thermosiphon circuit becomes lower than the outside air temperature, the working fluid is not condensed in the air-cooled condenser that uses the outside air. In this case, the working fluid circulating in the thermosiphon circuit is condensed only by the cold-heat heat exchanger that uses the cold heat of the refrigeration cycle. As a result, the amount of energy consumed by the refrigeration cycle to generate cold heat increases, such as an increase in the amount of electric power consumed by the compressor constituting the refrigeration cycle.

The present disclosure provides an equipment cooling device capable of reducing energy consumption.

According to one aspect of the present disclosure, an equipment cooling device that cools a target equipment by a thermosiphon circuit that uses cold heat of a refrigeration cycle and cold heat of outside air includes:

a cooler configured to cool the target equipment by latent heat of vaporization of the working fluid;

a cold-heat heat exchanger that radiates heat of the working fluid evaporated by the cooler by utilizing the cold heat of the low-temperature and low-pressure refrigerant circulating in the refrigeration cycle to condense the working fluid;

an air-cooled heat exchanger that radiates heat of the working fluid evaporated by the cooler by utilizing the cold heat of the outside air to condense the working fluid;

a gas pipe to guide the refrigerant evaporated in the cooler to the cold-heat heat exchanger and the air-cooled heat exchanger;

a liquid pipe to guide the refrigerant condensed by the cold-heat heat exchanger and the air-cooled heat exchanger to the cooler;

an outside air temperature detector to detect an outside air temperature;

a saturation temperature detector to detect a saturation temperature of the working fluid circulating through a thermosiphon circuit including the cooler, the cold-heat heat exchanger, the air-cooled heat exchanger, the gas pipe and the liquid pipe; and

a heat radiation controller that adjusts a heat radiation amount of the working fluid flowing through the cold-heat heat exchanger so that the saturation temperature of the working fluid is higher than the outside air temperature.

Accordingly, since the saturation temperature of the working fluid becomes higher than the outside air temperature due to the operation of the heat radiation controller, the working fluid is condensed in both the air-cooled heat exchanger and the cold-heat heat exchanger. Therefore, it is possible to reduce the cold heat amount in the refrigeration cycle used by the cold-heat heat exchanger for condensing the working fluid, by the cold heat amount used by the air-cooled heat exchanger that uses the cold heat of the outside air to condense the working fluid. Therefore, the equipment cooling device can reduce the amount of energy consumed by the refrigeration cycle to generate cold heat, such as an increase in the amount of electric power consumed by the compressor constituting the refrigeration cycle.

According to another aspect, an equipment cooling device that cools a target equipment by a thermosiphon circuit that uses cold heat of a refrigeration cycle and cold heat of outside air includes:

a cooler configured to cool the target equipment by latent heat of vaporization of the working fluid;

a working-fluid heat exchanger that radiates heat of the working fluid evaporated by the cooler to condense the working fluid;

a gas pipe to guide the refrigerant evaporated in the cooler to the working-fluid heat exchanger;

a liquid pipe to guide the refrigerant condensed in the working-fluid heat exchanger to the cooler;

a coolant circuit in which cooling water flows to exchange heat with the working fluid flowing through the working-fluid heat exchanger;

an air radiator provided in the coolant circuit to exchange heat between the cooling water circulating through the coolant circuit and outside air;

a water-refrigerant heat exchanger provided in the coolant circuit to exchange heat between the cooling water circulating in the coolant circuit and low-temperature and low-pressure refrigerant circulating in the refrigeration cycle;

an outside air temperature detector to detect an outside air temperature;

a cooling water temperature detector to detect temperature of the cooling water circulating in the coolant circuit; and

a heat radiation controller that adjusts a heat radiation amount of the cooling water flowing through the water-refrigerant heat exchanger so that the temperature of the cooling water circulating in the coolant circuit becomes higher than the outside air temperature.

Accordingly, the cooling water circulating in the coolant circuit is cooled by the air radiator using the cold heat of the outside air and the water-refrigerant heat exchanger using the cold heat of the low-temperature and low-pressure refrigerant circulating in the refrigeration cycle. The working-fluid heat exchanger condenses the working fluid by heat exchange between the working fluid and the cooling water cooled by the air radiator and the water-refrigerant heat exchanger. In such a configuration, the temperature of the cooling water circulating in the coolant circuit becomes higher than the outside air temperature due to the operation of the heat radiation controller, so that the cooling water circulating in the coolant circuit is cooled using both the cold heat of the low-temperature and low-pressure refrigerant circulating in the refrigeration cycle and the cold heat of the outside air. Therefore, the amount of cold heat of the refrigeration cycle used for cooling the cooling water can be reduced by the amount of the cold heat of the outside air used for cooling the cooling water circulating in the coolant circuit. Therefore, the equipment cooling device can reduce the amount of energy consumed by the refrigeration cycle to generate cold heat.

According to another aspect, an equipment cooling device that cools a target equipment by a thermosiphon circuit that uses cold heat of a refrigeration cycle and cold heat of outside air includes:

a cooler configured to cool the target equipment by latent heat of vaporization of the working fluid;

a working-fluid heat exchanger that radiate heat of the working fluid evaporated by the cooler to condense the working fluid;

a gas pipe to guide the refrigerant evaporated in the cooler to the working-fluid heat exchanger;

a liquid pipe to guide the refrigerant condensed in the working-fluid heat exchanger to the cooler;

a coolant circuit in which cooling water flows to exchange heat with the working fluid flowing through the working-fluid heat exchanger;

an air radiator provided in the coolant circuit to exchange heat between the cooling water circulating through the coolant circuit and outside air;

an outside air temperature detector to detect an outside air temperature;

a saturation temperature detector to detect a saturation temperature of the working fluid circulating in a thermosiphon circuit including the cooler, the working-fluid heat exchanger, the gas pipe and the liquid pipe; and

a heat radiation controller that adjusts a heat radiation amount of the working fluid flowing through the working-fluid heat exchanger so that the saturation temperature of the working fluid is higher than the outside air temperature, wherein

the working-fluid heat exchanger is configured to exchange heat among the working fluid flowing through the working-fluid heat exchanger, a low-temperature and low-pressure refrigerant circulating in the refrigeration cycle, and the cooling water circulating in the coolant circuit.

Accordingly, the cooling water circulating in the coolant circuit is cooled by the air radiator that uses the cold heat of the outside air. The working-fluid heat exchanger condenses the working fluid by heat exchange among the cooling water cooled by the air radiator, the low-temperature and low-pressure refrigerant circulating in the refrigeration cycle, and the working fluid. Therefore, the working-fluid heat exchanger can condense the working fluid using both the cold heat of the low-temperature and low-pressure refrigerant circulating in the refrigeration cycle and the cold heat of the outside air. In such a configuration, when the saturation temperature of the working fluid becomes higher than the outside air temperature due to the operation of the heat radiation controller, the working-fluid heat exchanger can condense the working fluid by utilizing both of the cold heat of the low-temperature and low-pressure refrigerant circulating in the refrigeration cycle and the cold heat of the outside air. Therefore, the amount of cold energy of the refrigeration cycle used for condensing the working fluid by the working-fluid heat exchanger can be reduced by the amount of the cold heat of the outside air used for condensing the working fluid by the working-fluid heat exchanger. Therefore, the equipment cooling device can reduce the amount of energy consumed by the refrigeration cycle to generate cold heat.

A reference numeral in parentheses attached to each component or the like indicates an example of correspondence between the component or the like and specific component or the like described in embodiments below.

Embodiments of the present disclosure will now be described with reference to the drawings. Parts that are identical or equivalent to each other in the following embodiments are assigned the same reference numerals and will not be described.

### First Embodiment

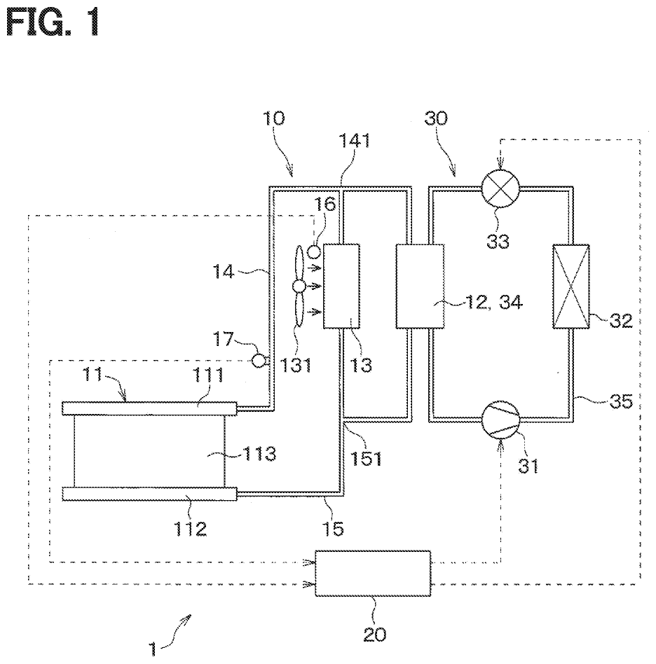

A first embodiment will be described with reference to FIGS. 1 to 6. An equipment cooling device 1 of the first embodiment is mounted on an electric vehicle (hereinafter, simply referred to as “vehicle”) such as an electric vehicle, a plug-in hybrid vehicle, or a hybrid vehicle. The target equipment to be cooled by the equipment cooling device 1 according to the first embodiment is a secondary battery (hereinafter, referred to as “battery pack 2”) mounted on a vehicle.

First, the battery pack 2 to be cooled by the equipment cooling device 1 will be described. The battery pack 2 installed in the vehicle is mounted as a large-size battery pack (that is, a power storage device) in which plural battery modules are stored, due to combination of battery cells 3, under a seat of a vehicle or under a trunk room. The electric power stored in the battery pack 2 is supplied to a vehicle driving motor via an inverter or the like. That is, the battery pack 2 stores and discharges electric power for driving a traveling motor and the like. The electric power stored in the battery pack 2 is also used to drive a compressor 31 provided in a refrigeration cycle 30 used as, for example, a cold heat supply source of an air conditioner for performing air-conditioning in a vehicle cabin.

When power is supplied to the battery pack 2 while the vehicle is running, the battery pack 2 generates heat. When the temperature of the battery pack 2 becomes high, not only the battery pack 2 cannot exhibit a sufficient function, but also the deterioration thereof is promoted. Therefore, it is necessary to limit the output and the input to reduce the self-heating. In order to secure the output and the input of the battery pack 2, a cooling device is required for maintaining the battery pack 2 at a predetermined temperature or lower. The temperature of the battery pack 2 is preferably maintained, for example, at about 10° C. to 40° C.

Further, in a season when the outside air temperature is high, such as in summer, the temperature of the battery pack 2 rises not only while the vehicle is running, but also while the vehicle is parked. Also, the battery pack 2 is often placed under the floor of the vehicle or under a trunk room. While the amount of heat applied to the battery pack 2 per unit time is small, the temperature of the battery pack 2 gradually rises due to being left for a long time. If the battery pack 2 is left in a high temperature state, the life of the battery pack 2 is shortened. Therefore, it is desired to maintain the temperature of the battery pack 2 at a predetermined temperature or less even during parking of a vehicle or the like.

Further, the battery pack 2 is constituted by the plural battery cells 3. If the temperatures of the battery cells 3 vary in the battery pack 2, the deterioration is biased among the battery cells 3, and the power storage performance is reduced. Since the battery pack 2 is configured by a series connection of the battery cells 3, the input/output characteristics of the battery pack 2 are determined in accordance with the characteristics of the battery cell 3 that has deteriorated the most. In order to exhibit desired performance of the battery pack 2 over a long period of time, it is important to equalize the temperatures so as to reduce temperature variations among the battery cells 3.

In general, the battery pack 2 is cooled by an air-cooling cooling unit using a blower and a cooling unit using cold heat of a vapor compression refrigeration cycle. However, the air-cooling cooling unit using a blower only blows air in the vehicle cabin, and thus has a low cooling capacity. Further, since the blower cools the battery pack 2 with sensible heat of air, the temperature difference between the upstream side and the downstream side in the air flow increases. As a result, the temperature variation among the battery cells 3 cannot be sufficiently suppressed.

Therefore, the equipment cooling device 1 of the present embodiment adopts a battery cooling method using a thermosiphon circuit 10 that adjusts the temperature of the battery pack 2 by natural circulation of the working fluid without forcibly circulating the working fluid by a compressor.

Next, the configuration of the equipment cooling device 1 will be described. As shown in FIG. 1, the equipment cooling device 1 includes a cooler 11, a cold-heat heat exchanger 12, an air-cooled heat exchanger 13, a gas pipe 14, a liquid pipe 15, an outside air temperature detector 16, a saturation temperature detector. 17, a heat radiation controller, and a control device 20. The cooler 11, the cold-heat heat exchanger 12, the air-cooled heat exchanger 13, the gas pipe 14, the liquid pipe 15, and the like are connected to each other to form a loop thermosiphon circuit 10. A predetermined amount of working fluid is sealed in the thermosiphon circuit 10 in a state where the inside thereof is evacuated. As the working fluid, for example, a chlorofluorocarbon-based refrigerant such as HFO-1234yf or HFC-134a is used. The filling amount of the working fluid is adjusted so that the liquid level of the working fluid is positioned in the middle of the cooler 11 in the height direction or in the gas pipe 14 and the liquid pipe 15.

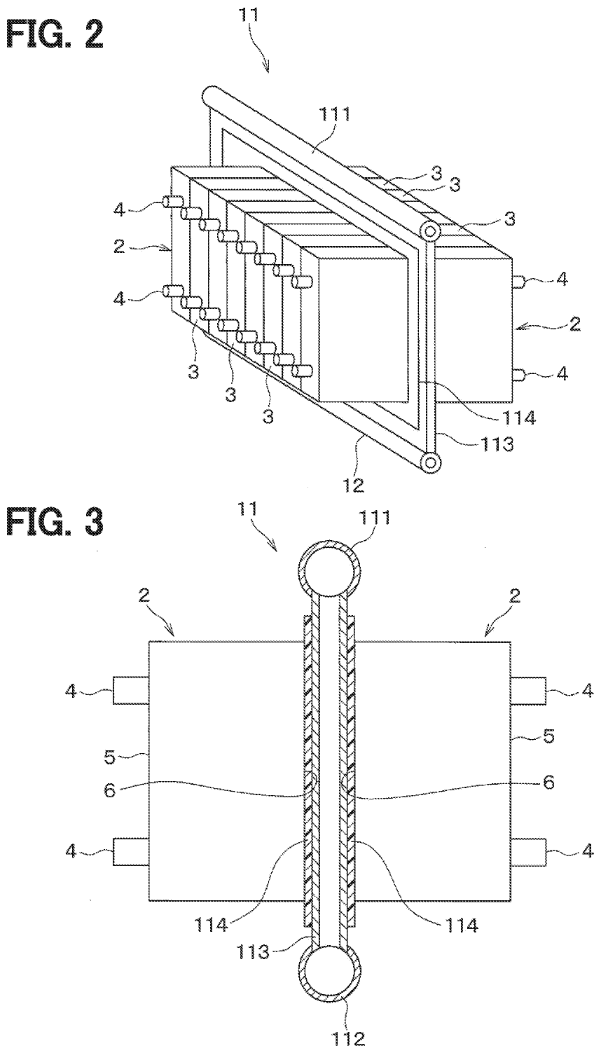

As shown in FIGS. 2 and 3, the cooler 11 includes a tubular upper header tank 111, a tubular lower header tank 112, and a heat exchange unit 113. The upper header tank 111 is provided at a position on the upper side in the cooler 11 in the gravity direction. The lower header tank 112 is provided at a position on the lower side in the cooler 11 in the gravity direction. The plural heat exchange units 113 have plural tubes (not shown) that communicate the flow path in the upper header tank 111 and the flow path in the lower header tank 112 with each other. The heat exchange unit 113 may have plural flow paths formed inside a plate-shaped member. Each component of the cooler 11 is formed of a metal having high thermal conductivity, such as aluminum or copper. Each component of the cooler 11 may be formed of a material having high thermal conductivity other than metal.

The battery pack 2 is installed outside the heat exchange unit 113 via an electrically insulating heat conductive sheet 114. The heat conductive sheet 114 ensures electrical insulation between the heat exchange unit 113 and the battery pack 2 and reduces the thermal resistance between the heat exchange unit 113 and the battery pack 2. In the present embodiment, the battery pack 2 has a surface 5 on which terminals 4 are provided, and a surface 6 opposite to the surface 5. The surface 6 is provided on the heat exchange unit 113 via the heat conductive sheet 114. Note that the heat conductive sheet 114 may be omitted, and the battery pack 2 and the heat exchange unit 113 may be directly connected to each other.

The battery cells 3 of the battery pack 2 are arranged in a direction intersecting with the gravity direction. Note that the arrangement of the battery pack 2 is not limited to those shown in FIGS. 1 to 3, and other installation method can be adopted. For example, the battery pack 2 may be installed such that the surface 5 on which the terminals 4 are provided faces upward in the gravity direction. In this case, a surface of the battery pack 2 that is perpendicular to the surface 5 on which the terminals 4 are provided is installed on the heat exchange unit 113 via the heat conductive sheet 114. Further, the number, shape, and the like of the battery cells 3 of the battery pack 2 are not limited to those shown in FIGS. 1 to 3.

The battery pack 2 can exchange heat with the working fluid inside the cooler 11. When the battery pack 2 generates heat, the liquid-phase working fluid in the cooler 11 evaporates. Thereby, the battery cells 3 are uniformly cooled by the latent heat of vaporization of the working fluid.

The gas pipe 14 includes a flow path for guiding the gas-phase working fluid evaporated inside the cooler 11 to the cold-heat heat exchanger 12 and the air-cooled heat exchanger 13. One end of the gas pipe 14 is connected to the upper header tank 111 of the cooler 11. A branch portion 141 is provided in the middle of the gas pipe 14. The other two ends of the gas pipe 14 are connected to the cold-heat heat exchanger 12 and the air-cooled heat exchanger 13, respectively. That is, the cold-heat heat exchanger 12 and the air-cooled heat exchanger 13 are connected in parallel.

Both the cold-heat heat exchanger 12 and the air-cooled heat exchanger 13 are arranged above the cooler 11 in the gravity direction. The gas-phase working fluid evaporated by the cooler 11 flows into the cold-heat heat exchanger 12 and the air-cooled heat exchanger 13 via the gas pipe 14.

The cold-heat heat exchanger 12 of the first embodiment is configured to exchange heat between a gas-phase working fluid flowing inside the cold-heat heat exchanger 12 and a low-temperature and low-pressure refrigerant circulating in the refrigeration cycle 30. The cold-heat heat exchanger 12 uses the cold heat of the low-temperature and low-pressure refrigerant circulating in the refrigeration cycle 30 to radiate heat of the working fluid to condense the working fluid.

The refrigeration cycle 30 will be described. The refrigeration cycle 30 includes a compressor 31, a refrigerant condenser 32, an expansion valve 33, a refrigerant evaporator 34, and a refrigerant pipe 35 connecting them. The refrigerant used in the refrigeration cycle 30 may be the same as the working fluid used in the thermosiphon circuit 10, or may be different. In the first embodiment, the refrigerant evaporator 34 included in the refrigeration cycle 30 and the cold-heat heat exchanger 12 included in the thermosiphon circuit 10 are the same or are integrally formed.

The compressor 31 compresses and discharges the refrigerant sucked from the refrigerant pipe 35 adjacent to the refrigerant evaporator 34. The compressor 31 is driven by receiving power from an electric motor (not shown) or a traveling engine of the vehicle. In addition, electric power is supplied from the battery pack 2 in the cooler 11 of the thermosiphon circuit 10 to an electric motor for driving the compressor 31. The high-pressure gas-phase refrigerant discharged from the compressor 31 flows into the refrigerant condenser 32. The refrigerant condenser 32 is a heat exchanger that exchanges heat between the high-pressure gas-phase refrigerant flowing into the refrigerant condenser 32 and outside air. The high-pressure gas-phase refrigerant flowing into the refrigerant condenser 32 is condensed by radiating heat to the outside air. The refrigerant flowing out of the refrigerant condenser 32 flows into the expansion valve 33 via a receiver (not shown).

The expansion valve 33 decompresses and expands the refrigerant flowing out of the refrigerant condenser 32. The refrigerant flowing out of the expansion valve 33 is in a mist-like gas-liquid two-phase state and flows into the refrigerant evaporator 34 (that is, the cold-heat heat exchanger 12). In the refrigerant evaporator 34 (that is, the cold-heat heat exchanger 12), heat is exchanged between the low-temperature and low-pressure refrigerant flowing through the refrigeration cycle 30 and the working fluid flowing through the thermosiphon circuit 10. At that time, the working fluid flowing through the thermosiphon circuit 10 is condensed by releasing heat to the low-temperature and low-pressure refrigerant flowing through the refrigeration cycle 30. The low-temperature and low-pressure refrigerant flowing through the refrigeration cycle 30 absorbs heat from the working fluid flowing through the thermosiphon circuit 10 to evaporate. The refrigerant flowing out of the refrigerant evaporator 34 is sucked into the compressor 31. In this manner, the cold-heat heat exchanger 12 of the first embodiment can radiate heat of the working fluid by using the cold heat of the low-temperature and low-pressure refrigerant circulating in the refrigeration cycle 30 to condense the working fluid.

The thermosiphon circuit 10 will be further described. The air-cooled heat exchanger 13 exchanges heat between a gas-phase working fluid flowing inside the air-cooled heat exchanger 13 and outside air. A fan 131 is provided in front of or behind the air-cooled heat exchanger 13. The air-cooled heat exchanger 13 is capable of performing heat exchange between a gas-phase working fluid flowing inside the air-cooled heat exchanger 13 and air or traveling air blown by the fan 131. The gas-phase working fluid flowing through the air-cooled heat exchanger 13 is condensed by releasing heat to the air passing through the air-cooled heat exchanger 13. That is, the air-cooled heat exchanger 13 uses the cold heat of the outside air to radiate the heat of working fluid to condense the working fluid. The air-cooled heat exchanger 13 is generally provided in an engine room in front of the vehicle.

The liquid pipe 15 includes a flow path for guiding the liquid-phase working fluid condensed inside the cold-heat heat exchanger 12 and the air-cooled heat exchanger 13 to the cooler 11. Two ends of the liquid pipe 15 are connected to the cold-heat heat exchanger 12 and the air-cooled heat exchanger 13, respectively. A junction 151 is provided in the middle of the liquid pipe 15. The other end of the liquid pipe 15 is connected to the lower header tank 112 of the cooler 11. As a result, the working fluid condensed to a liquid phase inside the cold-heat heat exchanger 12 and the air-cooled heat exchanger 13 flows through the liquid pipe 15 by its own weight and flows into the cooler 11.

Note that the gas pipe 14 and the liquid pipe 15 are names for convenience, and do not mean a passage through which only a gas-phase or liquid-phase working fluid flows. That is, the working fluid in both the gas phase and the liquid phase may flow into both the gas pipe 14 and the liquid pipe 15. Further, the shapes and the like of the gas pipe 14 and the liquid pipe 15 can be appropriately changed to be easily mounted to a vehicle.

Further, the equipment cooling device 1 includes an outside air temperature detector 16, a saturation temperature detector 17, a heat radiation controller, a control device 20, and the like, in addition to the thermosiphon circuit 10.

The outside air temperature detector 16 is a temperature sensor for detecting the temperature of the outside air. The outside air temperature detector 16 is provided, for example, near the air-cooled heat exchanger 13. The position at which the outside air temperature detector 16 is provided is not limited to the vicinity of the air-cooled heat exchanger 13 and can be set arbitrarily. The temperature of the outside air detected by the outside air temperature detector 16 is transmitted to the control device 20.

The control device 20 has a microcomputer including a processor for performing control processing and arithmetic processing and a storage unit, such as a ROM and a RAM, for storing a program and data, as well as peripheral circuits thereof. The storage unit of the control device 20 includes a non-transitory, tangible storage medium. The control device 20 performs various types of control processing and arithmetic processing on the basis of the programs stored in the storage unit, thereby controlling the operation of each device connected to an output port.

The saturation temperature detector 17 is a means for detecting the saturation temperature of the working fluid circulating in the thermosiphon circuit 10. In the following description, the saturation temperature of the working fluid circulating in the thermosiphon circuit 10 is simply referred to as “saturation temperature” or “saturation temperature of the working fluid”. Various means can be adopted as the saturation temperature detector 17. For example, a temperature sensor for detecting the saturation temperature of the working fluid is used as the saturation temperature detector 17. The saturation temperature of the working fluid is substantially the same anywhere in the thermosiphon circuit 10. Therefore, the temperature sensor as the saturation temperature detector 17 can be provided at an arbitrary position in the thermosiphon circuit 10. The saturation temperature of the working fluid detected by the temperature sensor as the saturation temperature detector 17 is transmitted to the control device 20.

The saturation temperature detector 17 may include, for example, a pressure sensor that detects the pressure in the thermosiphon circuit 10. The pressure in the thermosiphon circuit 10 detected by the pressure sensor as the saturation temperature detector 17 is transmitted to the control device 20. In that case, the relationship between the pressure of the working fluid and the saturation temperature is stored in the storage unit of the control device 20. Therefore, the control device 20 can detect the saturation temperature of the working fluid based on the pressure in the thermosiphon circuit 10. In this specification, “detecting the saturation temperature of the working fluid” also includes that the control device 20 calculates or estimates the saturation temperature of the working fluid based on a predetermined physical quantity.

The saturation temperature detector 17 may be, for example, a battery temperature sensor (not shown) that detects the temperature of the battery pack 2. The battery temperature detected by the battery temperature sensor as the saturation temperature detector 17 is transmitted to the control device 20. In this case, the relationship between a change rate of the battery temperature over time and the saturation temperature of the working fluid, and the thermal resistance between the battery pack 2 and the cooler 11 are acquired in advance by experiments or the like, and the relationship is stored in the storage unit of the control device 20. Therefore, the control device 20 can detect the saturation temperature of the working fluid based on the change in the battery temperature.

In addition, the control device 20 may detect the saturation temperature of the working fluid based on the state quantity of the equipment cooling device 1 such as the pressure, temperature and flow rate of the refrigerant circulating in the refrigeration cycle 30, or the outside air temperature in addition to the battery temperature. The flow rate of the refrigerant circulating in the refrigeration cycle 30 may be estimated from the number of revolutions of the compressor 31 provided in the refrigeration cycle 30.

When a coolant circuit is installed in the equipment cooling device 1 as in an eighth embodiment described later, the control device 20 may detect the saturation temperature of the working fluid based on a state quantity such as the temperature or flow rate of the cooling water circulating through the coolant circuit, or the outside air temperature, in addition to the battery temperature.

The heat radiation controller is a means for adjusting the heat radiation amount of the working fluid flowing through the cold-heat heat exchanger 12 so that the saturation temperature of the working fluid becomes higher than the outside air temperature. The heat radiation controller can have various configurations such as the compressor 31 or the expansion valve 33 included in the refrigeration cycle 30 to adjust the flow rate or temperature of the refrigerant circulating in the refrigeration cycle 30. The control device 20 controls the drive of the heat radiation controller such as the compressor 31 or the expansion valve 33. The control device 20 also functions as a heat radiation controller. The control device 20 as the heat radiation controller reduces the heat radiation amount of the working fluid flowing through the cold-heat heat exchanger 12 by decreasing the flow rate of the refrigerant circulating in the refrigeration cycle 30 or increasing the temperature of the refrigerant.

Further, as will be described later with reference to FIG. 14 in a sixth embodiment, the heat radiation controller may be, for example, a flow control valve 18 to adjust the flow rate of the working fluid flowing into the cold-heat heat exchanger 12 of the thermosiphon circuit 10. The control device 20 controls the drive of the flow control valve 18 as the heat radiation controller. In that case, the flow control valve 18 decreases the flow rate of the working fluid flowing into the cold-heat heat exchanger 12 so as to reduce the heat radiation amount of the working fluid flowing through the cold-heat heat exchanger 12. The specific configuration and operation of the heat radiation controller will be described in the second to tenth embodiments described later.

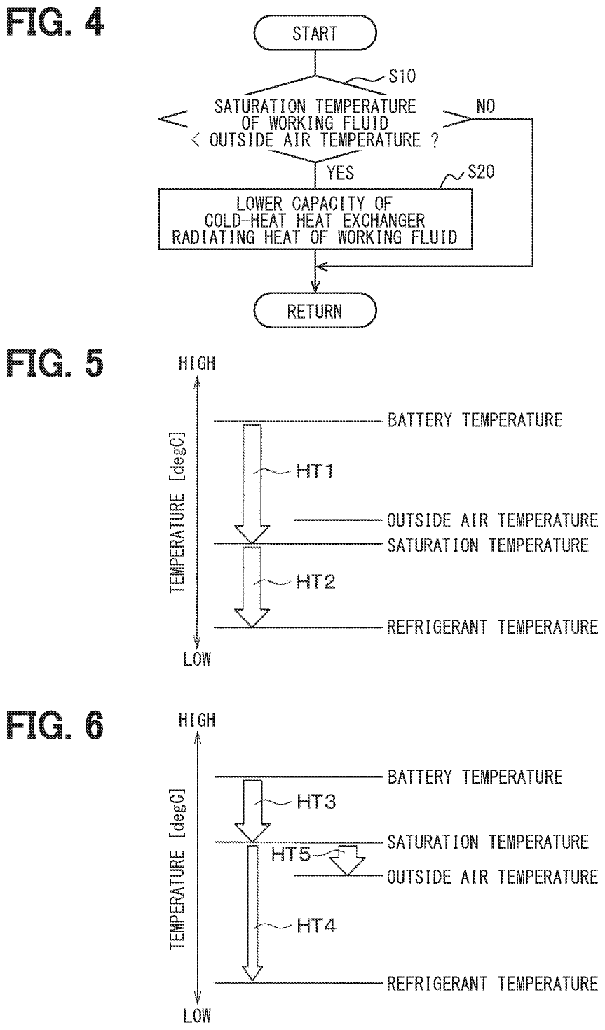

Next, a control process executed by the control device 20 included in the equipment cooling device 1 of the first embodiment will be described with reference to a flowchart of FIG. 4.

When the process is started, in step S10, the control device 20 determines whether the saturation temperature of the working fluid detected by the saturation temperature detector 17 is lower than the outside air temperature detected by the outside air temperature detector 16. When the control device 20 determines that the saturation temperature of the working fluid is lower than the outside air temperature, the control device 20 proceeds to step S20.

In step S20, the control device 20 controls the driving of the heat radiation controller to reduce the capacity of the cold-heat heat exchanger 12 radiating heat of the working fluid. The heat radiation controller reduces the heat radiation amount of the working fluid flowing through the cold-heat heat exchanger 12 by, for example, decreasing the flow rate of the refrigerant circulating in the refrigeration cycle 30 or increasing the temperature of the refrigerant. Thereby, the saturation temperature of the working fluid circulating in the thermosiphon circuit 10 is raised. This process is performed until the saturation temperature of the working fluid becomes higher than the outside air temperature.

When the control device 20 determines in step S10 that the saturation temperature of the working fluid is higher than the outside air temperature, the control device 20 ends the process once. Then, after a predetermined time has elapsed, the control device 20 starts the process again from step S10. In this way, the equipment cooling device 1 of the first embodiment can make the saturation temperature of the working fluid higher than the outside air temperature.

Subsequently, an equipment cooling device of a comparative example will be described for comparison with the equipment cooling device 1 of the first embodiment described above. The controller provided in the equipment cooling device of the comparative example does not perform the control processing as described in the first embodiment, and performs cooling of the battery pack 2 in a timely manner. FIG. 5 shows heat transfer among the cooler 11, the cold-heat heat exchanger 12, and the air-cooled heat exchanger 13 when the equipment cooling device of the comparative example cools the battery pack 2. In each of the drawings, the saturation temperature of the working fluid circulating in the thermosiphon circuit 10 is simply described as “saturation temperature”.

In the equipment cooling device of the comparative example, as shown by an arrow HT1 in FIG. 5, in the cooler 11, heat moves from the battery pack 2 to the working fluid inside the cooler 11. Thereby, the battery pack 2 is cooled. In the cold-heat heat exchanger 12, heat is transferred from the working fluid inside the cold-heat heat exchanger 12 to the low-temperature and low-pressure refrigerant circulating in the refrigeration cycle 30, as indicated by an arrow HT2. Thereby, the working fluid is condensed in the cold-heat heat exchanger 12.

However, as described above, since the control device 20 included in the equipment cooling device of the comparative example performs cooling of the battery pack 2 in a timely manner, the saturation temperature of the working fluid is lower than the outside air temperature. Therefore, in the air-cooled heat exchanger 13, heat is not released from the working fluid inside the air-cooled heat exchanger 13 to the outside air. That is, the working fluid is not condensed in the air-cooled heat exchanger 13. Therefore, the working fluid circulating in the thermosiphon circuit 10 is condensed only by the cold-heat heat exchanger 12 that uses the cold heat of the refrigeration cycle 30. As a result, in the equipment cooling device of the comparative example, when the saturation temperature of the working fluid is lower than the outside air temperature, the amount of electric power consumed by the compressor 31 of the refrigeration cycle 30 is increased. Thus, the amount of energy consumed by the refrigeration cycle 30 to produce cold heat is increased.

In contrast, according to the first embodiment, when the equipment cooling device 1 cools the battery pack 2, heat transfer generated among the cooler 11, the cold-heat heat exchanger 12, and the air-cooled heat exchanger 13 is illustrated in FIG. 6. Also in the equipment cooling device 1 of the first embodiment, heat is transferred from the battery pack 2 to the working fluid in the cooler 11, as indicated by an arrow HT3 in FIG. 6. Thereby, the battery pack 2 is cooled. Further, as indicated by an arrow HT4, in the cold-heat heat exchanger 12, heat moves from the working fluid inside the cold-heat heat exchanger 12 to the low-temperature and low-pressure refrigerant circulating in the refrigeration cycle 30. Thereby, the working fluid is condensed in the cold-heat heat exchanger 12.

As described above, in the equipment cooling device 1 of the first embodiment, the heat radiation amount of the working fluid flowing through the cold-heat heat exchanger 12 is adjusted by driving the heat radiation controller. Therefore, the amount of heat transferred from the working fluid flowing through the cold-heat heat exchanger 12 to the refrigerant flowing through the refrigeration cycle 30 is small. Thus, in FIG. 6, the saturation temperature of the working fluid is higher than the outside air temperature. Therefore, in the air-cooled heat exchanger 13, as shown by an arrow HT5, heat moves from the working fluid inside the air-cooled heat exchanger 13 to the outside air, and the working fluid is condensed in the air-cooled heat exchanger 13. That is, the working fluid circulating in the thermosiphon circuit 10 is condensed in both the cold-heat heat exchanger 12 that uses the cold heat of the refrigeration cycle 30 and the air-cooled heat exchanger 13 that uses the cold heat of the outside air. Therefore, the amount of energy consumed by the refrigeration cycle 30 to generate cold heat is reduced.

The equipment cooling device 1 according to the first embodiment described above has the following effects.

(1) In the first embodiment, the heat radiation controller adjusts the heat radiation amount of the working fluid flowing through the cold-heat heat exchanger 12 so that the saturation temperature of the working fluid is higher than the outside air temperature. Accordingly, since the saturation temperature of the working fluid becomes higher than the outside air temperature, the working fluid is condensed in both the air-cooled heat exchanger 13 and the cold-heat heat exchanger 12. Therefore, the amount of cold heat of the refrigeration cycle 30 used by the cold-heat heat exchanger 12 for condensing the working fluid can be reduced by the amount of cold heat of the outside air used by the air-cooled heat exchanger 13 for condensing the working fluid. Therefore, the equipment cooling device 1 can reduce the amount of energy consumed by the refrigeration cycle 30 to generate cold heat. As a result, the equipment cooling device 1 can increase the traveling distance of the electric vehicle by the vehicle traveling motor.

(2) In the first embodiment, the cold-heat heat exchanger 12 is configured to exchange heat between the low-temperature and low-pressure refrigerant circulating in the refrigeration cycle 30 and the working fluid flowing through the cold-heat heat exchanger 12. According to this, the cold-heat heat exchanger 12 can condense the working fluid by directly using the cold heat of the low-temperature and low-pressure refrigerant circulating in the refrigeration cycle 30.

(3) In the first embodiment, the heat radiation controller adjusts the heat radiation amount of the working fluid flowing through the cold-heat heat exchanger 12 by adjusting the flow rate or the temperature of the refrigerant circulating in the refrigeration cycle 30. That is, the heat radiation controller reduces the heat radiation amount of the working fluid flowing through the cold-heat heat exchanger 12 by reducing the flow rate of the refrigerant circulating in the refrigeration cycle 30 or increasing the temperature of the refrigerant.

### Second Embodiment

A second embodiment will be described. The second embodiment specifically describes the configuration of the heat radiation controller with respect to the first embodiment, and the other configuration is the same as that of the first embodiment.

The heat radiation controller included in the equipment cooling device 1 of the second embodiment is the compressor 31 of the refrigeration cycle 30. The compressor 31 serving as the heat radiation controller reduces the rotation speed, thereby reducing the flow rate of the refrigerant circulating in the refrigeration cycle 30. Thus, it is possible to make adjustments to reduce the heat radiation amount of the working fluid flowing through the refrigerant evaporator 34 (that is, the cold-heat heat exchanger 12).

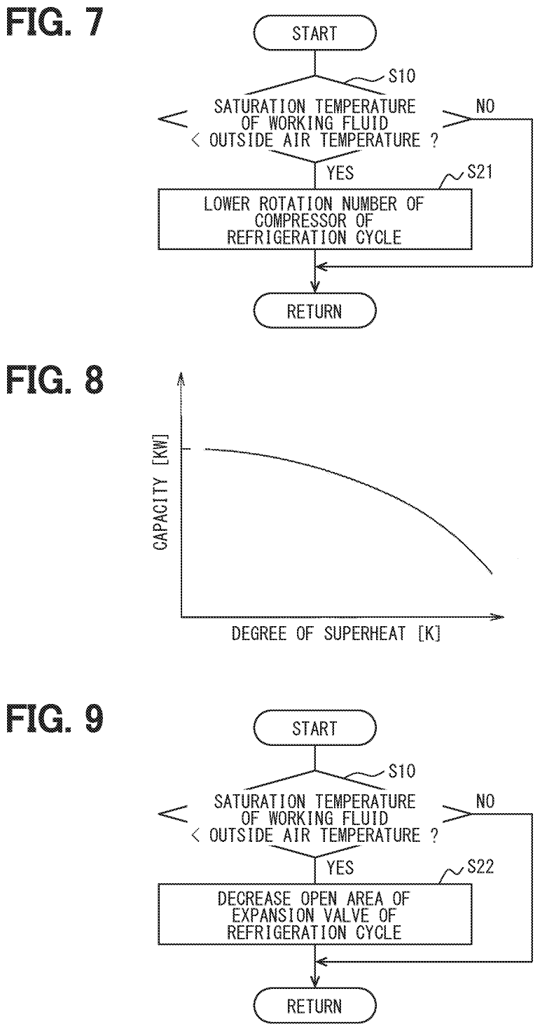

A control process executed by the control device 20 included in the equipment cooling device 1 according to the second embodiment will be described with reference to a flowchart of FIG. 7.

The processing in step S10 is the same as the processing described in the first embodiment. When the control device 20 determines that the saturation temperature of the working fluid is lower than the outside air temperature, the control device 20 proceeds to step S21.

In step S21, the control device 20 reduces the rotation speed of the compressor 31 as a heat radiation controller. Thereby, the flow rate of the refrigerant circulating in the refrigeration cycle 30 decreases. Therefore, the heat radiation capability of the refrigerant evaporator 34 (that is, the cold-heat heat exchanger 12) is reduced, and the heat radiation amount of the working fluid flowing therethrough is reduced. Therefore, the saturation temperature of the working fluid circulating in the thermosiphon circuit 10 is raised. This process is performed until the saturation temperature of the working fluid becomes higher than the outside air temperature.

The heat radiation controller provided in the equipment cooling device 1 of the second embodiment reduces the rotation speed of the compressor 31 so that the heat radiation amount of the working fluid flowing through the cold-heat heat exchanger 12 becomes small. The equipment cooling device 1 of the second embodiment can also achieve the same operation and effects as those of the first embodiment.

### Third Embodiment

A third embodiment will be described. The third embodiment also specifically describes the configuration of the heat radiation controller with respect to the first embodiment, and the other configuration is the same as that of the first embodiment.

The heat radiation controller included in the equipment cooling device 1 of the third embodiment is the expansion valve 33 of the refrigeration cycle 30. The expansion valve 33 as a heat radiation controller reduces the passage area so as to reduce the heat radiation amount of the working fluid flowing through the refrigerant evaporator 34 (that is, the cold-heat heat exchanger 12).

FIG. 8 is a graph illustrating the relationship between the degree of superheat of the refrigerant flowing out of the refrigerant evaporator 34 and the cooling capacity of the refrigerant evaporator 34 in the refrigeration cycle 30. When the passage area of the expansion valve 33 is reduced, the flow rate of the gas-liquid two-phase refrigerant flowing into the refrigerant condenser 32 is reduced. Therefore, the region of the gaseous refrigerant inside the refrigerant evaporator 34 is increased, and the degree of superheat of the refrigerant flowing out of the refrigerant evaporator 34 is raised. Therefore, the cooling capacity of the refrigerant evaporator 34 decreases.

When the degree of superheat of the refrigerant flowing out of the refrigerant evaporator 34 increases, the suction density of the refrigerant sucked into the compressor 31 decreases. Therefore, the flow rate of the circulating refrigerant in the refrigeration cycle 30 decreases, and the cooling capacity of the refrigerant evaporator 34 decreases. Therefore, the heat radiation amount of the working fluid flowing through the refrigerant evaporator 34 (that is, the cold-heat heat exchanger 12) is reduced.

Next, a control process executed by the control device 20 included in the equipment cooling device 1 according to the third embodiment will be described with reference to a flowchart of FIG. 9.

The processing in step S10 is the same as the processing described in the first embodiment. When the control device 20 determines that the saturation temperature of the working fluid is lower than the outside air temperature, the control device 20 proceeds to step S22.

In step S22, the control device 20 reduces the passage area of the expansion valve 33 as the heat radiation controller. As a result, the cooling capacity of the refrigerant evaporator 34 (that is, the cold-heat heat exchanger 12) decreases, and the amount of heat radiation of the working fluid flowing therethrough decreases. Therefore, the saturation temperature of the working fluid circulating in the thermosiphon circuit 10 is raised. This process is performed until the saturation temperature of the working fluid becomes higher than the outside air temperature.

The heat radiation controller included in the equipment cooling device 1 according to the third embodiment reduces the heat radiation amount of the working fluid flowing through the cold-heat heat exchanger 12 by reducing the passage area of the expansion valve 33. The equipment cooling device 1 of the third embodiment can also achieve the same operation and effects as those of the first and second embodiments.

### Fourth Embodiment

A fourth embodiment will be described. The fourth embodiment also specifically describes the configuration of the heat radiation controller with respect to the first embodiment, and the other configuration is the same as that of the first embodiment.

As shown in FIG. 10, a condenser fan 321 is provided in front of or behind a refrigerant condenser 32 provided in the refrigeration cycle 30 of the fourth embodiment. The refrigerant condenser 32 is a heat exchanger that exchanges heat between air or traveling air blown by the condenser fan 321 and a gas-phase refrigerant flowing inside the refrigerant condenser 32. The gas-phase refrigerant flowing through the refrigerant condenser 32 is condensed by radiating heat to the air passing through the refrigerant condenser 32.

The heat radiation controller included in the equipment cooling device 1 of the fourth embodiment is the condenser fan 321 in the refrigeration cycle 30. The condenser fan 321 serving as the heat radiation controller reduces the amount of air blown to the refrigerant condenser 32 to reduce the heat radiation amount of the working fluid flowing through the refrigerant evaporator 34 (that is, the cold-heat heat exchanger 12).

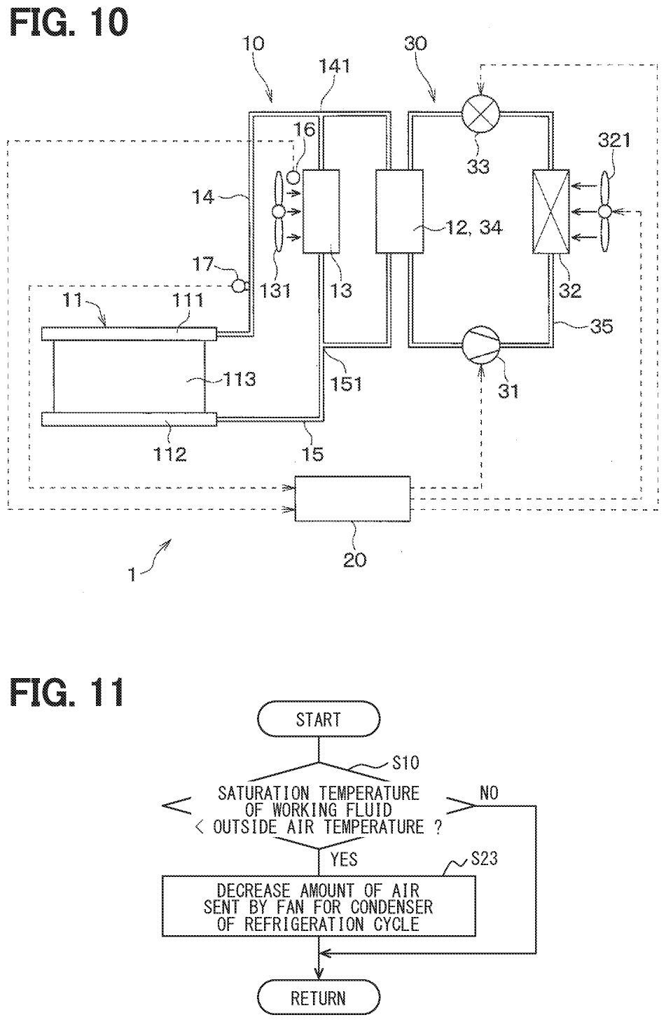

A control process executed by the control device 20 included in the equipment cooling device 1 according to the fourth embodiment will be described with reference to a flowchart in FIG. 11.

The processing in step S10 is the same as the processing described in the first embodiment. When the control device 20 determines that the saturation temperature of the working fluid is lower than the outside air temperature, the control device 20 proceeds to step S23.

In step S23, the control device 20 reduces the amount of air sent by the condenser fan 321 as the heat radiation controller. This reduces the condensation heat amount by reducing the amount of air passing through the refrigerant condenser 32. Further, the degree of supercooling of the high-pressure refrigerant flowing out of the refrigerant condenser 32 becomes small. Therefore, the temperature of the refrigerant flowing into the refrigerant evaporator 34 (that is, the cold-heat heat exchanger 12) via the expansion valve 33 is raised. Therefore, the cooling capacity of the refrigerant evaporator 34 (that is, the cold-heat heat exchanger 12) is reduced, and the amount of heat radiation of the working fluid flowing therethrough is reduced. Therefore, the saturation temperature of the working fluid circulating in the thermosiphon circuit 10 increases. This process is performed until the saturation temperature of the working fluid becomes higher than the outside air temperature.

The heat radiation controller included in the equipment cooling device 1 of the fourth embodiment is configured to reduce the heat radiation amount of the working fluid flowing through the cold-heat heat exchanger 12 by decreasing the amount of air blown by the condenser fan 321. The equipment cooling device 1 of the fourth embodiment can also provide the same operation and effects as those of the first to third embodiments.

### Fifth Embodiment

A fifth embodiment will be described. The fifth embodiment also specifically describes the configuration of the heat radiation controller with respect to the first embodiment, and the other configuration is the same as that of the first embodiment.

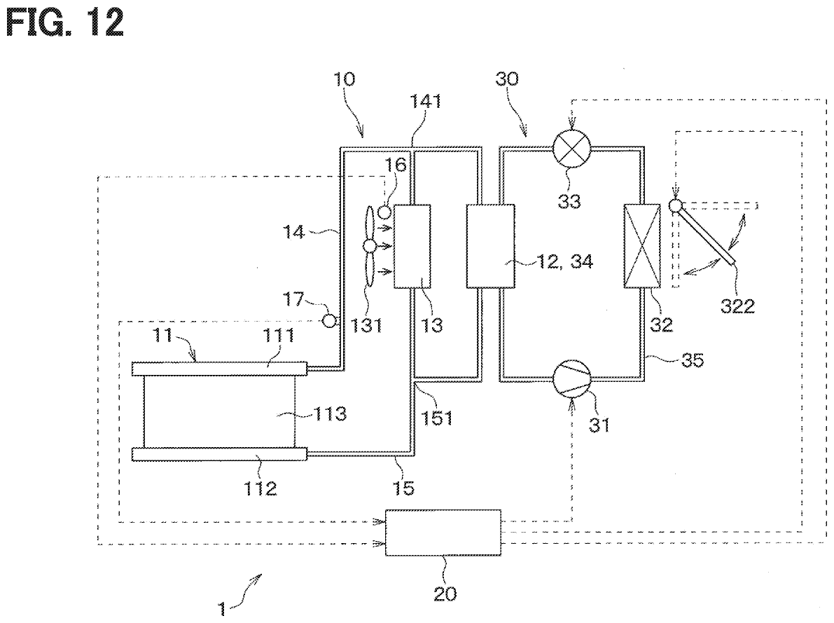

As shown in FIG. 12, a shutter 322 is provided in front of the refrigerant condenser 32 in the refrigeration cycle 30 of the fifth embodiment. The shutter 322 can adjust the amount of air passing through the refrigerant condenser 32 by adjusting the open ratio. The gas-phase refrigerant flowing through the refrigerant condenser 32 is condensed by radiating heat to the air passing through the refrigerant condenser 32.

The heat radiation controller provided in the equipment cooling device 1 of the fifth embodiment is the shutter 322 provided in front of the refrigerant condenser 32 in the refrigeration cycle 30. The shutter 322 as the heat radiation controller reduces the opening ratio of the shutter 322 to reduce the amount of air passing through the refrigerant condenser 32. Thus, it is possible to reduce the heat radiation amount of the working fluid flowing through the refrigerant evaporator 34 (that is, the cold-heat heat exchanger 12).

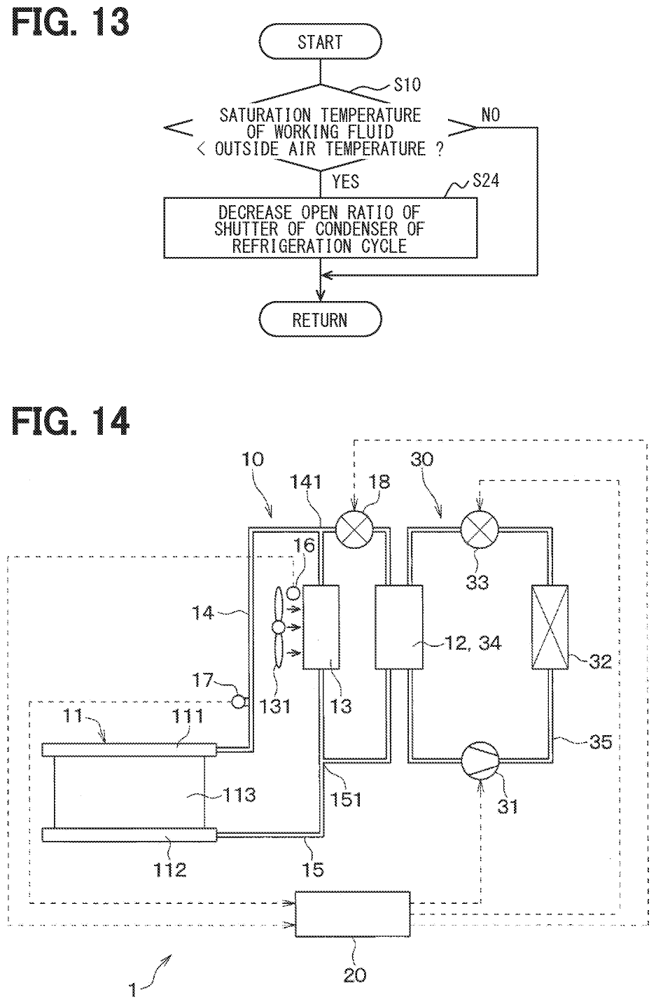

A control process executed by the control device 20 included in the equipment cooling device 1 according to the fifth embodiment will be described with reference to a flowchart in FIG. 13.

The processing in step S10 is the same as the processing described in the first embodiment. When the control device 20 determines that the saturation temperature of the working fluid is lower than the outside air temperature, the control device 20 to step S24.

In step S24, the control device 20 reduces the open ratio of the shutter 322 as the heat radiation controller. This reduces the condensation heat amount by reducing the amount of air passing through the refrigerant condenser 32, and reduces the degree of supercooling of the high-pressure refrigerant flowing out of the refrigerant condenser 32. Therefore, the temperature of the refrigerant flowing into the refrigerant evaporator 34 (that is, the cold-heat heat exchanger 12) via the expansion valve 33 is raised. Therefore, the cooling capacity of the refrigerant evaporator 34 (that is, the cold-heat heat exchanger 12) is reduced, and the amount of heat radiation of the working fluid flowing therethrough is reduced. Therefore, the saturation temperature of the working fluid circulating in the thermosiphon circuit 10 is raised. This process is performed until the saturation temperature of the working fluid becomes higher than the outside air temperature.

The heat radiation controller included in the equipment cooling device 1 according to the fifth embodiment adjusts the heat radiation amount of the working fluid flowing through the cold-heat heat exchanger 12 to be small due to the decrease in the open ratio of the shutter 322. The equipment cooling device 1 of the fifth embodiment can also provide the same operation and effects as those of the first to fourth embodiments.

### Sixth Embodiment

A sixth embodiment will be described. The sixth embodiment also specifically describes the configuration of the heat radiation controller with respect to the first embodiment, and is otherwise the same as the first embodiment.

As shown in FIG. 14, in the sixth embodiment, a flow control valve 18 is provided in the gas pipe 14 of the thermosiphon circuit 10. The flow control valve 18 is provided at a portion of the gas pipe 14 between the branch portion 141 and the cold-heat heat exchanger 12. The flow control valve 18 is capable of adjusting the flow rate of the working fluid flowing from the cooler 11 through the gas pipe 14 into the cold-heat heat exchanger 12.

The heat radiation controller included in the equipment cooling device 1 of the sixth embodiment is the flow control valve 18 provided in the thermosiphon circuit 10. The flow control valve 18 as a heat radiation controller adjusts the flow rate of the working fluid flowing through the cold-heat heat exchanger 12 so that the heat radiation amount of the working fluid by the cold-heat heat exchanger 12 becomes small.

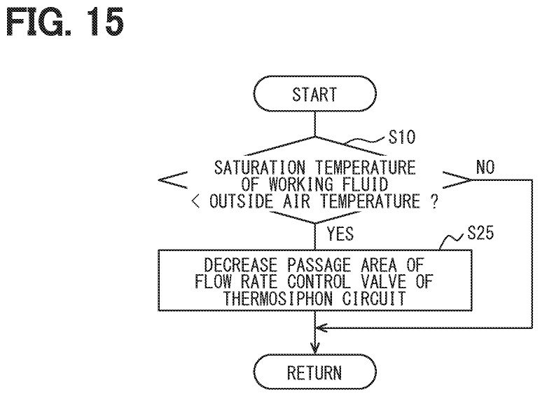

A control process executed by the control device 20 included in the equipment cooling device 1 according to the sixth embodiment will be described with reference to a flowchart of FIG. 15.

The processing in step S10 is the same as the processing described in the first embodiment. When the control device 20 determines that the saturation temperature of the working fluid is lower than the outside air temperature, the control device 20 proceeds to step S25.

In step S25, the control device 20 narrows the passage area of the flow control valve 18 as the heat radiation controller. Thereby, the flow rate of the working fluid flowing through the cold-heat heat exchanger 12 decreases. Therefore, the heat radiation amount of the working fluid by the cold-heat heat exchanger 12 is reduced. Therefore, the saturation temperature of the working fluid circulating in the thermosiphon circuit 10 is raised. This process is performed until the saturation temperature of the working fluid becomes higher than the outside air temperature.

The heat radiation controller included in the equipment cooling device 1 of the sixth embodiment is configured to reduce the heat radiation amount of the working fluid by the cold-heat heat exchanger 12 by reducing the passage area of the flow control valve 18. The equipment cooling device 1 of the sixth embodiment can also achieve the same operation and effects as those of the first to fifth embodiments.

### Seventh Embodiment

A seventh embodiment will be described. The seventh embodiment is different from the first to sixth embodiments in that the configuration of the refrigeration cycle 30 and the configuration of the heat radiation controller, and the other configurations are the same as those in the first to sixth embodiments.

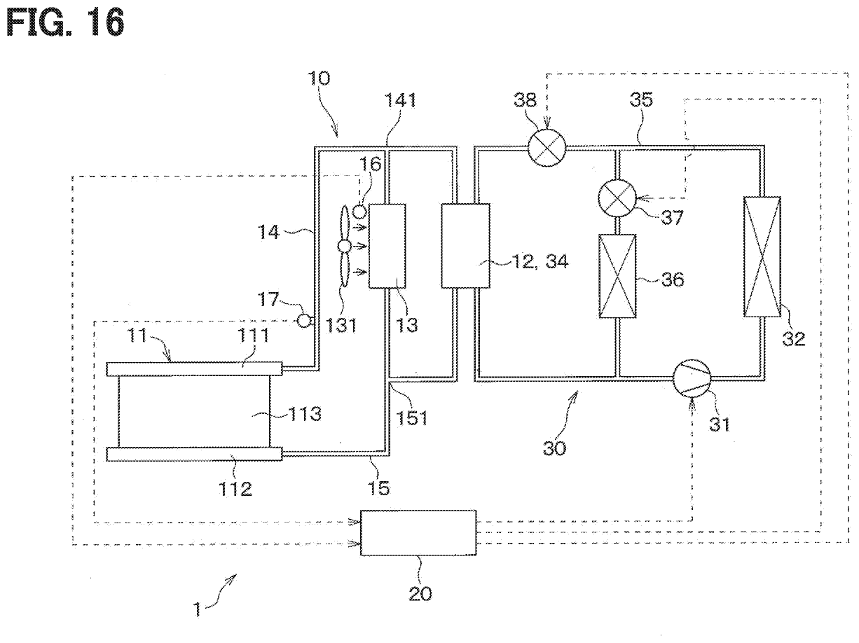

As shown in FIG. 16, the refrigeration cycle 30 of the seventh embodiment includes plural evaporators. One of the evaporators is an air-conditioning evaporator 36. The air-conditioning evaporator 36 is used as a cold heat supply source of an air conditioner that performs air-conditioning in a vehicle cabin. The other of the evaporators is the refrigerant evaporator 34 (that is, the cold-heat heat exchanger 12). The refrigerant evaporator 34 (that is, the cold-heat heat exchanger 12) is used for condensing the working fluid circulating in the thermosiphon circuit 10. The air-conditioning evaporator 36 and the refrigerant evaporator 34 (that is, the cold-heat heat exchanger 12) are connected in parallel by a refrigerant pipe 35.

An air-conditioning expansion valve 37 is provided in the refrigerant pipe 35 on the upstream side of the air-conditioning evaporator 36. The air-conditioning expansion valve 37 decompresses and expands the refrigerant flowing into the air-conditioning evaporator 36. The air-conditioning expansion valve 37 may use a temperature automatic expansion valve whose passage area is automatically adjusted according to the degree of superheat of the refrigerant on the downstream side of the air-conditioning evaporator 36. Alternatively, an electronic expansion valve whose passage area can be adjusted according to a signal from the control device 20 may be used.

An equipment cooling expansion valve 38 is provided in the refrigerant pipe 35 on the upstream side of the cold-heat heat exchanger 12. The equipment cooling expansion valve 38 decompresses and expands the refrigerant flowing into the cold-heat heat exchanger 12. The equipment cooling expansion valve 38 is an electronic expansion valve whose passage area can be adjusted according to a signal from the control device 20.

The heat radiation controller provided in the equipment cooling device 1 of the seventh embodiment is the equipment cooling expansion valve 38 provided in the refrigeration cycle 30. The equipment cooling expansion valve 38 as the heat radiation controller reduces the flow rate of the refrigerant flowing through the refrigerant evaporator 34 (that is, the cold-heat heat exchanger 12) in the refrigeration cycle 30, thereby reducing the heat radiation amount of the working fluid flowing through the refrigerant evaporator 34 (i.e., the cold-heat heat exchanger 12).

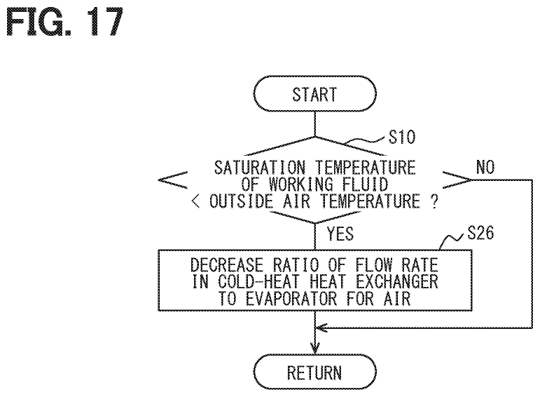

Next, a control process executed by the control device 20 included in the equipment cooling device 1 according to the seventh embodiment will be described with reference to the flowchart in FIG. 17.

The processing in step S10 is the same as the processing described in the first embodiment. When the control device 20 determines that the saturation temperature of the working fluid is lower than the outside air temperature, the control device 20 proceeds to step S26.

In step S26, the control device 20 reduces the passage area of the equipment cooling expansion valve 38 as the heat radiation controller. Thereby, in the refrigeration cycle 30, the flow rate of the refrigerant flowing through the refrigerant evaporator 34 (that is, the cold-heat heat exchanger 12) is smaller than the flow rate of the refrigerant flowing through the air-conditioning evaporator 36. Therefore, the heat radiation amount of the working fluid by the refrigerant evaporator 34 (that is, the cold-heat heat exchanger 12) is reduced. Therefore, the saturation temperature of the working fluid circulating in the thermosiphon circuit 10 is raised. This process is performed until the saturation temperature of the working fluid becomes higher than the outside air temperature.

In the heat radiation controller provided in the equipment cooling device 1 of the seventh embodiment, the heat radiation amount of the working fluid by the cold-heat heat exchanger 12 is reduced by reducing the passage area of the equipment cooling expansion valve 38. The equipment cooling device 1 of the seventh embodiment can also achieve the same operation and effects as those of the first to sixth embodiments. Regarding the method of operating the equipment cooling expansion valve 38, the passage area may be intermittently set substantially zero, and the ratio of the flow rate may be controlled by increasing the time period in which the passage area is zero between time periods in which the refrigerant flows. When the above operation is performed, the ratio of flow rate may be adjusted by adjusting the time ratio for opening an on-off valve, in case where the automatic temperature expansion valve and the on-off valve are connected in series.

### Eighth Embodiment

An eighth embodiment will be described hereafter. The eighth embodiment is different from the seventh embodiment in that a coolant circuit is provided and the configuration of a heat radiation controller is changed. The other configuration is the same as that of the seventh embodiment.

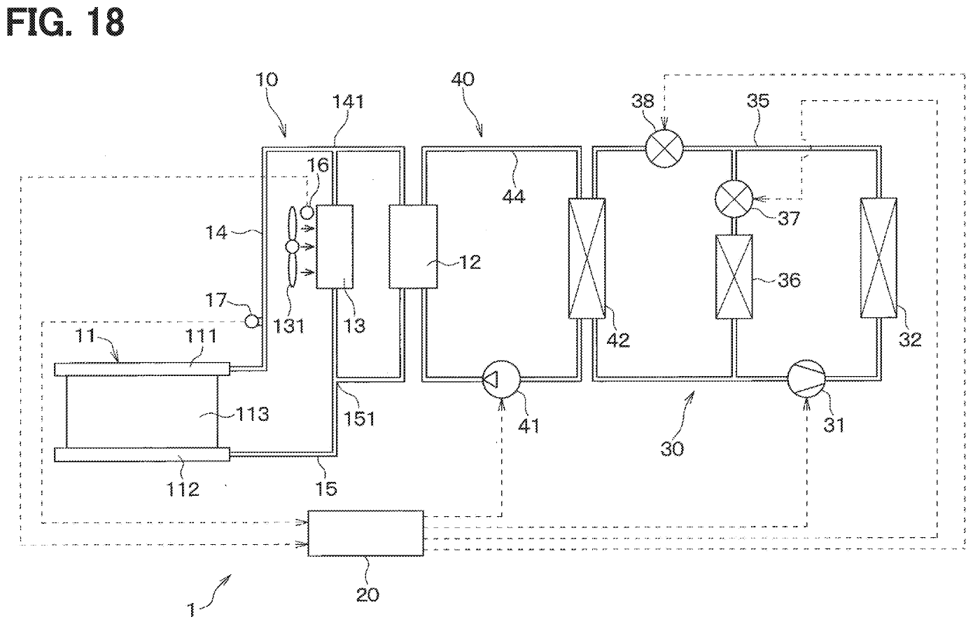

As shown in FIG. 18, the equipment cooling device 1 of the eighth embodiment includes a coolant circuit 40 between the thermosiphon circuit 10 and the refrigeration cycle 30. The coolant circuit 40 has a pump 41, a water-refrigerant heat exchanger 42, a cold-heat heat exchanger 12, and a pipe 44 connecting them. Cooling water flows through the coolant circuit 40. The pump 41 circulates cooling water through the coolant circuit 40. The water-refrigerant heat exchanger 42 exchanges heat between the cooling water circulating in the coolant circuit 40 and the low-temperature and low-pressure refrigerant circulating in the refrigeration cycle 30. Thereby, the cooling water circulating in the coolant circuit 40 is cooled by the cold heat of the low-temperature and low-pressure refrigerant circulating in the refrigeration cycle 30.

The cold-heat heat exchanger 12 according to the eighth embodiment is a water-working fluid heat exchange configured so that heat is exchanged between the cooling water circulating in the coolant circuit 40 and the working fluid circulating in the thermosiphon circuit 10. The working fluid circulating through the thermosiphon circuit 10 radiates heat to the cooling water circulating through the coolant circuit 40 to condense when flowing through the cold-heat heat exchanger 12.

The heat radiation controller provided in the equipment cooling device 1 of the eighth embodiment is the pump 41 provided in the coolant circuit 40. The pump 41 as the heat radiation controller can reduce the heat radiation amount of the working fluid by the cold-heat heat exchanger 12 by reducing the flow rate of the cooling water circulating in the coolant circuit 40.

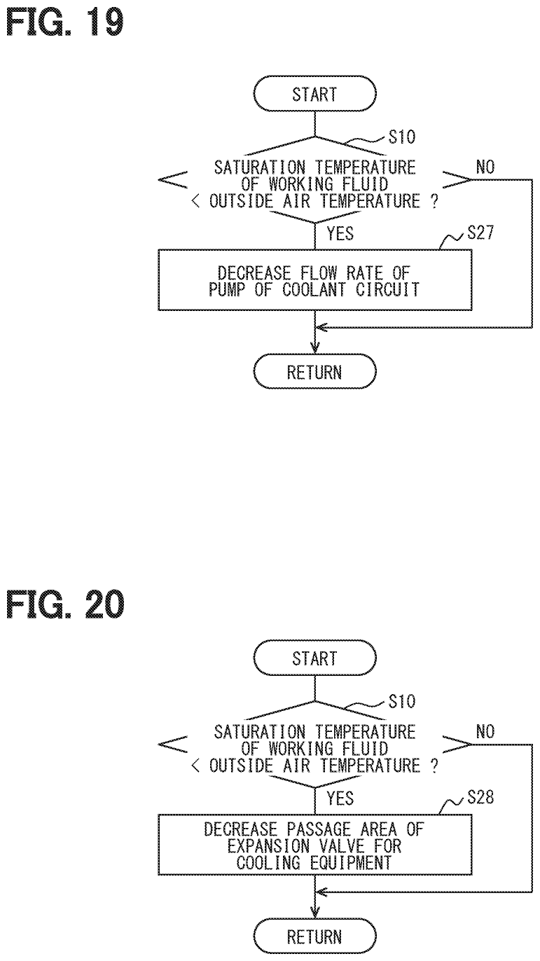

Next, a control process executed by the control device 20 included in the equipment cooling device 1 according to the eighth embodiment will be described with reference to the flowchart in FIG. 19.

The processing in step S10 is the same as the processing described in the first embodiment. When the control device 20 determines that the saturation temperature of the working fluid is lower than the outside air temperature, the control device 20 proceeds to step S27.

In step S27, the control device 20 reduces the discharge flow rate of the pump 41 as the heat radiation controller. Thereby, the flow rate of the cooling water circulating in the coolant circuit 40 decreases, and the flow rate of the cooling water flowing through the cold-heat heat exchanger 12 also decreases. Therefore, the heat radiation amount of the working fluid by the cold-heat heat exchanger 12 is reduced. Therefore, the saturation temperature of the working fluid circulating in the thermosiphon circuit 10 is raised. This process is performed until the saturation temperature of the working fluid becomes higher than the outside air temperature.

In the heat radiation controller provided in the equipment cooling device 1 of the eighth embodiment, the heat radiation amount of the working fluid by the cold-heat heat exchanger 12 decreases due to the decrease in the discharge flow rate of the pump 41 of the coolant circuit 40. That is, the pump 41 as the heat radiation controller can adjust the amount of cold heat supplied from the refrigeration cycle 30 to the cold-heat heat exchanger 12 by controlling the flow rate of the cooling water circulating through the coolant circuit 40. Further, in the eighth embodiment, the refrigerant pipe 35 of the refrigeration cycle 30 can be shortened by providing the coolant circuit 40 between the thermosiphon circuit 10 and the refrigeration cycle 30. The equipment cooling device 1 of the eighth embodiment can also achieve the same operation and effects as those of the first to seventh embodiments.

### Ninth Embodiment

A ninth embodiment will be described hereafter. The ninth embodiment is different from the eighth embodiment in that the configuration of the heat radiation controller is changed, and the rest is the same as the eighth embodiment.

The configuration of the equipment cooling device 1 of the ninth embodiment is the same as the configuration of the eighth embodiment shown in FIG. 18. However, the heat radiation controller provided in the equipment cooling device 1 of the ninth embodiment is the equipment cooling expansion valve 38 provided in the refrigeration cycle 30. The equipment cooling expansion valve 38 as the heat radiation controller reduces the flow rate of the refrigerant flowing through the water-refrigerant heat exchanger 42 in the refrigeration cycle 30, thereby reducing the capacity of the water-refrigerant heat exchanger 42 cooling the cooling water.

A control process executed by the control device 20 included in the equipment cooling device 1 according to the ninth embodiment will be described with reference to a flowchart of FIG. 20.

The processing in step S10 is the same as the processing described in the first embodiment. When the control device 20 determines that the saturation temperature of the working fluid is lower than the outside air temperature, the control device 20 proceeds to step S28.

In step S28, the control device 20 reduces the passage area of the equipment cooling expansion valve 38 as the heat radiation controller. Thereby, the flow rate of the refrigerant flowing through the water-refrigerant heat exchanger 42 in the refrigeration cycle 30 decreases, and the cooling capacity of the cooling water by the water-refrigerant heat exchanger 42 decreases. Therefore, the temperature of the cooling water flowing through the cold-heat heat exchanger 12 is raised, and the amount of heat radiation of the working fluid by the cold-heat heat exchanger 12 decreases. Therefore, the saturation temperature of the working fluid circulating in the thermosiphon circuit 10 is raised. This process is performed until the saturation temperature of the working fluid becomes higher than the outside air temperature.

In the heat radiation controller provided in the equipment cooling device 1 of the ninth embodiment, the heat radiation amount of the working fluid by the cold-heat heat exchanger 12 becomes smaller due to the reduction in the passage area of the equipment cooling expansion valve 38. The equipment cooling device 1 of the ninth embodiment can also achieve the same operation and effects as those of the first to eighth embodiments.

### Tenth Embodiment

A tenth embodiment will be described hereafter. In the tenth embodiment, the configuration of the thermosiphon circuit 10, the coolant circuit 40, and the like is changed from the first to ninth embodiments.

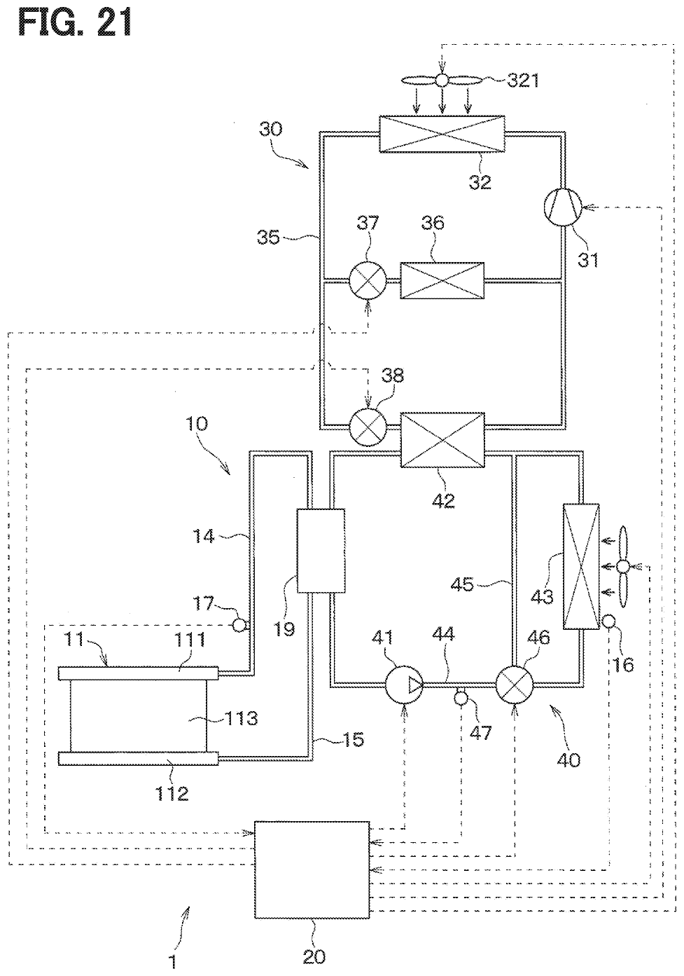

As shown in FIG. 21, the equipment cooling device 1 of the tenth embodiment includes a cooler 11, a working-fluid heat exchanger 19, a gas pipe 14, a liquid pipe 15, a coolant circuit 40, an air radiator 43, a water-refrigerant heat exchanger 42, an outside air temperature detector 16, a saturation temperature detector 17, a cooling water temperature detector 47, a heat radiation controller, and a control device 20. The cooler 11 and the saturation temperature detector 17 are substantially the same as those described in the first embodiment.

The working-fluid heat exchanger 19 provided in the equipment cooling device 1 of the tenth embodiment is a water-working fluid heat exchanger, i.e., a water-cooled condenser, configured to exchange heat between the working fluid circulating in the thermosiphon circuit 10 and the cooling water circulating in the coolant circuit 40. The working fluid evaporated in the cooler 11 flows from the gas pipe 14 into the working-fluid heat exchanger 19, and is condensed by releasing heat to the cooling water circulating in the coolant circuit 40.

The coolant circuit 40 has a pump 41 for circulating cooling water. The cooling water that has absorbed heat from the working fluid in the working-fluid heat exchanger 19 flows to the air radiator 43 and the water-refrigerant heat exchanger 42 provided in the coolant circuit 40. Note that the pump 41 and a cooling water temperature detector 47 are provided between the working-fluid heat exchanger 19 and the air radiator 43. The cooling water temperature detector 47 is a temperature sensor that detects the temperature of the cooling water circulating in the coolant circuit 40. The temperature of the cooling water detected by the cooling water temperature detector 47 is transmitted to the control device 20.

The air radiator 43 provided in the coolant circuit 40 is a heat exchanger that exchanges heat between the cooling water circulating in the coolant circuit 40 and outside air. The cooling water flowing into the air radiator 43 is cooled by radiating heat to the outside air. An outside air temperature detector 16 is provided near the air radiator 43. The position where the outside air temperature detector 16 is provided is not limited to the vicinity of the air radiator 43, and can be set arbitrarily.

The coolant circuit 40 is provided with a bypass pipe 45 that connects the pipe 44 on the upstream side of the air radiator 43 and the pipe 44 on the downstream side of the air radiator 43. A flow path switching valve 46 is provided at an end of the bypass pipe 45. The flow path switching valve 46 is, for example, a three-way valve. The flow path switching valve 46 switches the cooling water circulating in the coolant circuit 40 to bypass the air radiator 43 and flow through the bypass pipe 45 or to flow through the air radiator 43.

The water-refrigerant heat exchanger 42 provided in the coolant circuit 40 is a heat exchanger that exchanges heat between the cooling water circulating in the coolant circuit 40 and the low-temperature and low-pressure refrigerant circulating in the refrigeration cycle 30. The working fluid flowing into the water-refrigerant heat exchanger 42 is cooled by radiating heat to the low-temperature and low-pressure refrigerant circulating in the refrigeration cycle 30. The refrigeration cycle 30 is configured such that the air-conditioning evaporator 36 used as a cold heat supply source of an air conditioner that performs air-conditioning in a vehicle cabin and the water-refrigerant heat exchanger 42 are connected in parallel.

The heat radiation controller included in the equipment cooling device 1 of the tenth embodiment can be, for example, an equipment cooling expansion valve 38 provided in the refrigeration cycle 30. The equipment cooling expansion valve 38 as a heat radiation controller reduces the opening degree of the passage to reduce the flow rate of the refrigerant flowing through the water-refrigerant heat exchanger 42 in the refrigeration cycle 30. Thus, the cooling capacity of the cooling water by the water-refrigerant heat exchanger 42 can be reduced.

In addition, the heat radiation controller included in the equipment cooling device 1 of the tenth embodiment may be the compressor 31 included in the refrigeration cycle 30 or the condenser fan 321 or the shutter 322 that can adjust the amount of outside air passing through the refrigerant condenser 32. The compressor 31 serving as the heat radiation controller lowers the rotation speed so that the temperature of the cooling water circulating in the coolant circuit 40 becomes higher than the outside air temperature to reduce the capacity of the water-refrigerant heat exchanger 42 cooling the cooling water. The condenser fan 321 or the like as a heat radiation controller also reduces the amount of outside air passing through the refrigerant condenser 32, so that the temperature of the cooling water becomes higher than the outside air temperature, to reduce the capacity of the water-refrigerant heat exchanger 42 cooling the cooling water. Thus, the cooling water circulating in the coolant circuit 40 is cooled by both the water-refrigerant heat exchanger 42 and the air radiator 43. That is, the cooling water circulating through the coolant circuit 40 is cooled using both the cold heat of the low-temperature and low-pressure refrigerant circulating through the refrigeration cycle 30 and the cold heat of the outside air. Therefore, the amount of cold heat of the refrigeration cycle 30 used for cooling the cooling water can be reduced by the amount of the cold heat of the outside air used for cooling the cooling water circulating in the coolant circuit 40. Therefore, the equipment cooling device 1 can reduce the amount of energy consumed by the refrigeration cycle 30 to generate cold heat. As a result, the equipment cooling device 1 can increase the traveling distance of the electric vehicle by the vehicle traveling motor.

In the tenth embodiment, the compressor 31, the condenser fan 321 and the like serving as the heat radiation controller may reduce the cooling capacity of the cooling water by the water-refrigerant heat exchanger 42 so that the saturation temperature of the working fluid circulating in the thermosiphon circuit 10 becomes higher than the outside air temperature. When the saturation temperature of the working fluid circulating in the thermosiphon circuit 10 and the temperature of the cooling water circulating in the coolant circuit 40 are both higher than the outside air temperature, the cooling water circulating in the coolant circuit 40 is cooled by both the water-refrigerant heat exchanger 42 and the air radiator 43. Therefore, the amount of cold heat of the refrigeration cycle 30 used for condensing the working fluid by the working-fluid heat exchanger 19 can be reduced by the cold heat of the outside air used for condensing the working fluid by the working-fluid heat exchanger 19 via the cooling water circulating in the coolant circuit 40. Therefore, the equipment cooling device 1 can reduce the amount of energy consumed by the refrigeration cycle 30 to generate cold heat.

### Eleventh Embodiment

An eleventh embodiment will be described hereafter. In the eleventh embodiment, the configuration of the thermosiphon circuit 10, the coolant circuit 40, and the like is changed from the first to tenth embodiments.

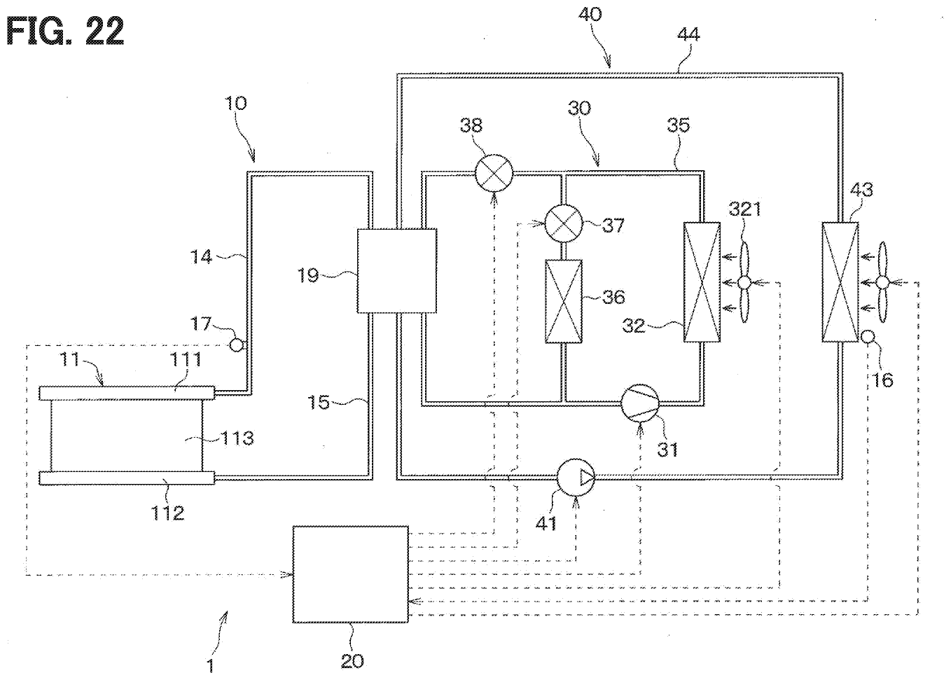

As shown in FIG. 22, the equipment cooling device 1 of the eleventh embodiment includes a cooler 11, a working-fluid heat exchanger 19, a gas pipe 14, a liquid pipe 15, a coolant circuit 40, an air radiator 43, an outside air temperature detector 16, a saturation temperature detector 17, a heat radiation controller, a control device 20, and the like. The cooler 11 and the saturation temperature detector 17 are substantially the same as those described in the first embodiment.

The working-fluid heat exchanger 19 provided in the equipment cooling device 1 of the eleventh embodiment is an integrated heat exchanger configured to exchange heat among the working fluid circulating through the thermosiphon circuit 10, the cooling water circulating through the coolant circuit 40, and the low-temperature and low-pressure refrigerant circulating through the refrigeration cycle 30. The working fluid evaporated in the cooler 11 and flowing into the working-fluid heat exchanger 19 from the gas pipe 14 radiates heat to cooling water circulating in the coolant circuit 40 and low-temperature and low-pressure refrigerant circulating in the refrigeration cycle 30 to condense. The cooling water absorbs heat from the working fluid in the working-fluid heat exchanger 19 and flows to the air radiator 43 provided in the coolant circuit 40.

The air radiator 43 provided in the coolant circuit 40 is a heat exchanger that exchanges heat between the cooling water circulating in the coolant circuit 40 and the outside air. The cooling water flowing into the air radiator 43 is cooled by radiating heat to the outside air. The outside air temperature detector 16 is provided near the air radiator 43. The position where the outside air temperature detector 16 is provided is not limited to the vicinity of the air radiator 43, and can be set arbitrarily.

The refrigeration cycle 30 is configured such that the air-conditioning evaporator 36 used as a cold heat supply source of an air conditioner that performs air-conditioning in a vehicle cabin and the working-fluid heat exchanger 19 are connected in parallel.

The heat radiation controller provided in the equipment cooling device 1 of the eleventh embodiment can be, for example, the equipment cooling expansion valve 38 provided in the refrigeration cycle 30. The equipment cooling expansion valve 38 as the heat radiation controller reduces the opening degree of the passage to reduce the flow rate of the refrigerant flowing through the working-fluid heat exchanger 19 in the refrigeration cycle 30. Thus, it is possible to reduce capacity of the working-fluid heat exchanger 19 cooling the working fluid.

In addition, the heat radiation controller included in the equipment cooling device 1 according to the eleventh embodiment may be the compressor 31 included in the refrigeration cycle 30 or the condenser fan 321 or the shutter 322 that can adjust the amount of outside air passing through the refrigerant condenser 32. The compressor 31 serving as the heat radiation controller can reduce the ability of the working-fluid heat exchanger 19 to condense the working fluid by reducing the rotation speed of the compressor 31. The condenser fan 321 or the shutter 322 as a heat radiation controller can reduce the amount of outside air passing through the refrigerant condenser 32 to reduce the ability of the working-fluid heat exchanger 19 to condense the working fluid. When the ability of the working-fluid heat exchanger 19 to condense the working fluid decreases, the amount of heat released from the working fluid decreases. Therefore, the heat radiation controller can increase the saturation temperature of the working fluid circulating in the thermosiphon circuit 10 and make the saturation temperature of the working fluid higher than the outside air temperature. Since the saturation temperature of the working fluid becomes higher than the outside air temperature due to the operation of the heat radiation controller, the working-fluid heat exchanger 19 uses both the cold heat of the low-temperature and low-pressure refrigerant circulating in the refrigeration cycle 30 and the cold heat of the outside air. Thus, the working fluid can be condensed. Therefore, the amount of cold heat of the refrigeration cycle 30 used for condensing the working fluid by the working-fluid heat exchanger 19 can be reduced by the use of the cold heat of the outside air for condensing the working fluid by the working-fluid heat exchanger 19. Therefore, the equipment cooling device 1 can reduce the amount of energy consumed by the refrigeration cycle 30 to generate cold heat. As a result, the equipment cooling device 1 can increase the traveling distance of the electric vehicle by the vehicle traveling motor.

### Twelfth Embodiment

A twelfth embodiment will be described hereafter. The twelfth embodiment describes a control method executed by the control device 20 included in the equipment cooling device 1 in the configuration described in the first to eleventh embodiments.

The control device 20 included in the equipment cooling device 1 of the twelfth embodiment is configured to select and execute a power-saving cooling mode and a quick cooling mode. The power-saving cooling mode is a control method controlling the heat radiation controller to reduce the heat radiation amount of the working fluid flowing through the cold-heat heat exchanger 12 or the working-fluid heat exchanger 19 so that the saturation temperature of the working fluid becomes higher than the outside air temperature, for performing normal cooling of the battery pack 2 with power saving. The quick cooling mode is a control method controlling the heat radiation controller to increase the heat radiation amount of the working fluid flowing through the cold-heat heat exchanger 12 so that the saturation temperature of the working fluid is lower than the outside air temperature, for rapidly cooling the battery pack 2.

The storage unit of the control device 20 stores a predetermined first threshold value Th1 and a predetermined second threshold value Th2 lower than the first threshold value Th1. The first threshold value Th1 and the second threshold value Th2 are set to an appropriate temperature (for example, in a range between 10° C. and 40° C.) or higher for the battery pack 2 to be cooled by the equipment cooling device 1.

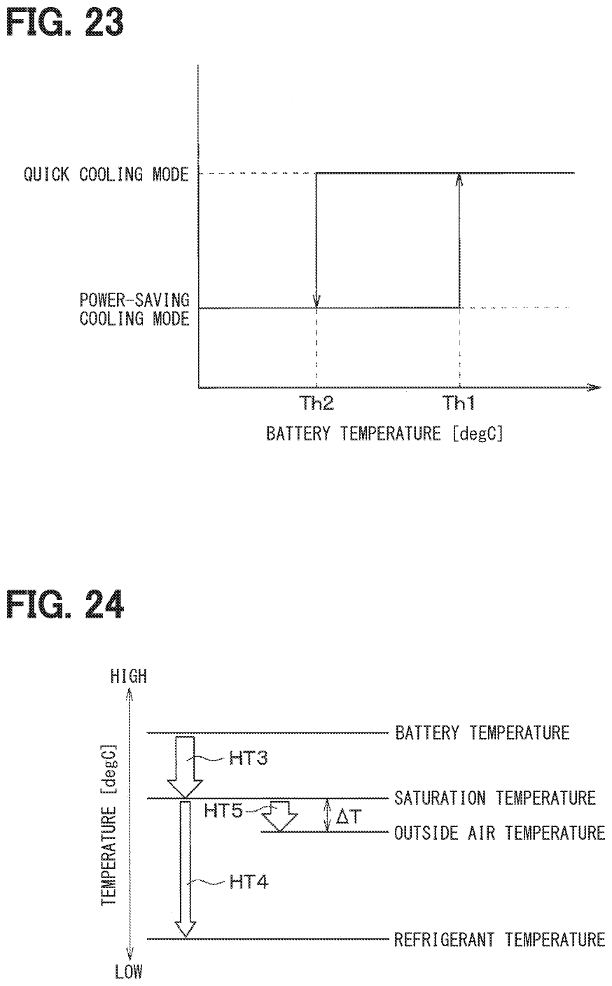

In FIG. 23, the horizontal axis represents the battery temperature. The vertical axis indicates the quick cooling mode at the upper stage and the power-saving cooling mode at the lower stage. When the battery temperature is higher than the first threshold Th1, the control device 20 executes the quick cooling mode until the battery temperature becomes equal to or lower than the second threshold Th2. When the quick cooling mode is not being executed and the battery temperature is lower than the first threshold Th1, the control device 20 executes the power-saving cooling mode.

In the twelfth embodiment described above, the equipment cooling device 1 can execute the quick cooling mode to rapidly cool the battery pack 2 for making the saturation temperature of the working fluid lower than the outside air temperature. The equipment cooling device 1 can condense the working fluid by using both the cold heat of the low-temperature and low-pressure refrigerant circulating in the refrigeration cycle 30 and the cold heat of the outside air by executing the power-saving cooling mode. In that case, the equipment cooling device 1 can reduce the amount of energy consumed by the refrigeration cycle 30 to generate cold heat.

### Thirteenth Embodiment

A thirteenth embodiment will be described hereafter. The thirteenth embodiment also describes a control method executed by the control device 20 included in the equipment cooling device 1 in the configuration described in the first to eleventh embodiments.

As shown in FIG. 24, the control device 20 included in the equipment cooling device 1 of the thirteenth embodiment is configured to be control the heat radiation controller such that a value obtained by subtracting the outside air temperature from the saturation temperature of the working fluid circulating in the thermosiphon circuit 10 becomes equal to or higher than a predetermined temperature ΔT. In other words, the control device 20 controls the heat radiation controller so that the saturation temperature of the working fluid circulating in the thermosiphon circuit 10 is higher than the outside air temperature, and that a difference between the saturation temperature of the working fluid and the outside air temperature is equal to or higher than the predetermined temperature ΔT. The predetermined temperature ΔT is set to an arbitrary value larger than 0. Specifically, the predetermined temperature ΔT is set to a temperature at which the air-cooled heat exchanger 13 or the working-fluid heat exchanger 19 can reliably use the cold heat of outside air to condense the working fluid.

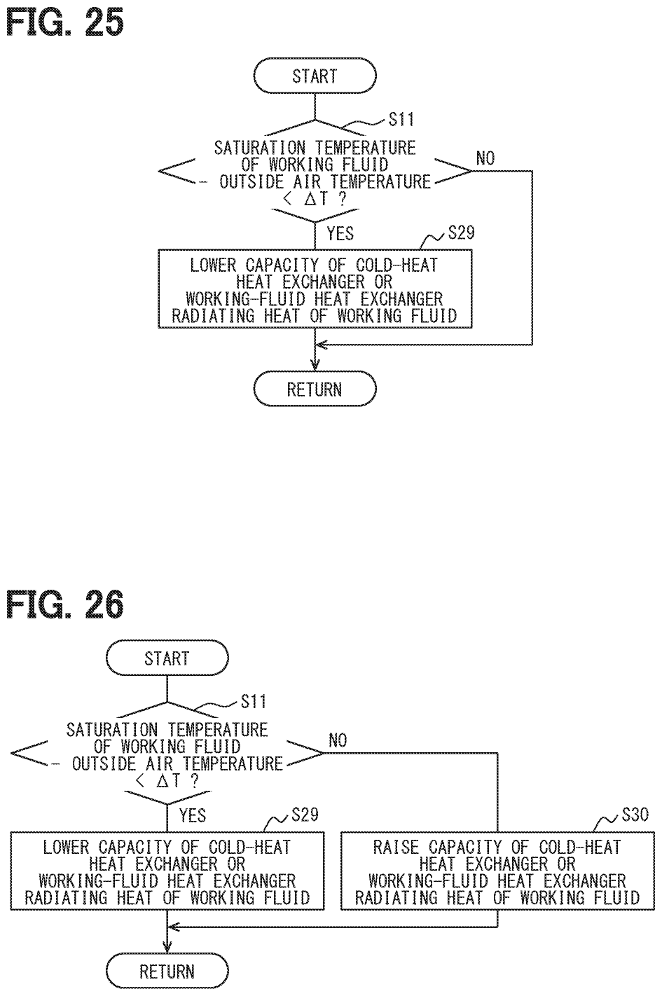

A control process executed by the control device 20 included in the equipment cooling device 1 according to the thirteenth embodiment will be described with reference to a flowchart in FIG. 25.

When this process is started, in step S11, the control device 20 calculates a value obtained by subtracting the outside air temperature detected by the outside air temperature detector 16 from the saturation temperature of the working fluid detected by the saturation temperature detector 17, and determines whether the value is smaller than ΔT. When the control device 20 determines that the value obtained by subtracting the outside air temperature from the saturation temperature of the working fluid is smaller than ΔT, the control device 20 proceeds to step S29.

In step S29, the control device 20 controls the heat radiation controller to reduce the heat radiation capability of the working fluid by the cold-heat heat exchanger 12 or the working-fluid heat exchanger 19. The heat radiation controller reduces the flow rate of the refrigerant circulating in the refrigeration cycle 30 or increases the temperature of the refrigerant, for example, to reduce the heat radiation amount of the working fluid flowing through the cold-heat heat exchanger 12 or the working-fluid heat exchanger 19. Thereby, the saturation temperature of the working fluid circulating in the thermosiphon circuit 10 is raised. This process is performed until the saturation temperature of the working fluid becomes higher than the outside air temperature.

In step S11, when the control device 20 determines that the value obtained by subtracting the outside air temperature from the saturation temperature of the working fluid is equal to or larger than ΔT, the process is temporarily ended. Then, after a lapse of a predetermined time, the control device 20 starts the process again from step S11. In this way, the equipment cooling device 1 of the thirteenth embodiment can control the heat radiation controller so that the value obtained by subtracting the outside air temperature from the saturation temperature of the working fluid is equal to or higher than the predetermined temperature ΔT.

In the thirteenth embodiment, the equipment cooling device 1 can reliably use the cold heat of the outside air for the condensation of the working fluid by the air-cooled heat exchanger 13 or the working-fluid heat exchanger 19. Therefore, the cold-heat heat exchanger 12 or the working-fluid heat exchanger 19 can reduce the amount of cold heat of the refrigeration cycle 30 used for condensing the working fluid by the amount of cold heat of the outside air for condensing the working fluid. Therefore, the equipment cooling device 1 can reduce the amount of energy consumed by the refrigeration cycle 30 to generate cold heat.

### Fourteenth Embodiment

A fourteenth embodiment will be described. The fourteenth embodiment is a modification of the control method described in the thirteenth embodiment.

The control device 20 included in the equipment cooling device 1 of the fourteenth embodiment controls the heat radiation controller so that a value obtained by subtracting the outside air temperature from the saturation temperature of the working fluid circulating in the thermosiphon circuit 10 becomes a constant temperature ΔT. In other words, the control device 20 controls the heat radiation controller such that the saturation temperature of the working fluid circulating in the thermosiphon circuit 10 is higher than the outside air temperature, and that the difference between the saturation temperature of the working fluid and the outside air temperature is a constant temperature ΔT.

A control process executed by the control device 20 included in the equipment cooling device 1 according to the fourteenth embodiment will be described with reference to a flowchart in FIG. 26.

The process in the case where the control device 20 determines in step S11 that the value obtained by subtracting the outside air temperature from the saturation temperature of the working fluid is smaller than ΔT, and the subsequent process in step S29 are the same as those in the thirteenth embodiment.

When the control device 20 determines in step S11 that the value obtained by subtracting the outside air temperature from the saturation temperature of the working fluid is equal to or greater than ΔT, the control device 20 proceeds to step S30. In step S30, the control device 20 controls the heat radiation controller to increase the heat radiation capability of the working fluid by the cold-heat heat exchanger 12 or the working-fluid heat exchanger 19. The heat radiation controller increases the flow rate of the refrigerant circulating in the refrigeration cycle 30 or lowers the temperature of the refrigerant, thereby increasing the amount of heat radiation of the working fluid flowing through the cold-heat heat exchanger 12 or the working-fluid heat exchanger 19. Thereby, the saturation temperature of the working fluid circulating in the thermosiphon circuit 10 decreases.

Then, the control device 20 once ends the process, and after a predetermined time has elapsed, the control device 20 restarts the process from step S11. In this way, the equipment cooling device 1 of the fourteenth embodiment adjusts the heat radiation controller so that the value obtained by subtracting the outside air temperature from the saturation temperature of the working fluid circulating in the thermosiphon circuit 10 becomes the constant temperature ΔT. The equipment cooling device 1 of the fourteenth embodiment described above can also achieve the same operation and effects as the thirteenth embodiment.

### Fifteenth Embodiment

A fifteenth embodiment will be described. The fifteenth embodiment is a modification of the control method described in the thirteenth and fourteenth embodiments.

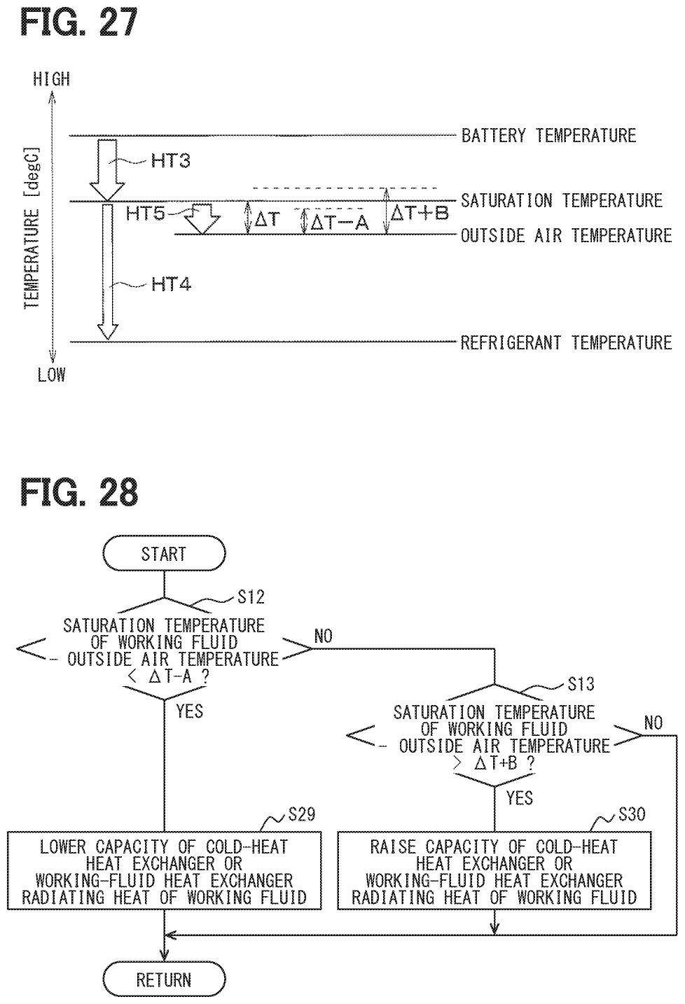

As shown in FIG. 27, the control device 20 of the fifteenth embodiment controls the heat radiation controller such that the value obtained by subtracting the outside air temperature from the saturation temperature of the working fluid circulating in the thermosiphon circuit 10 is in a temperature range between a predetermined lower limit temperature T-A and a predetermined upper limit temperature T+B. The temperature range is set at which the air-cooled heat exchanger 13 or the working-fluid heat exchanger 19 can use the cold heat of outside air to condense the working fluid. The temperature range is set at which the working fluid circulating in the thermosiphon circuit 10 can cool the battery pack 2 to an appropriate temperature.

A control process executed by the control device 20 included in the equipment cooling device 1 according to the fifteenth embodiment will be described with reference to a flowchart in FIG. 28.

When this process is started, in step S12, the control device 20 calculates a value obtained by subtracting the outside air temperature detected by the outside air temperature detector 16 from the saturation temperature of the working fluid detected by the saturation temperature detector 17, and determines whether the value is lower than the lower limit temperature T-A. If the control device 20 determines that the value obtained by subtracting the outside air temperature from the saturation temperature of the working fluid is smaller than the lower limit temperature T-A, the control device 20 proceeds to step S29.

The processing in step S29 is the same as the processing described in the thirteenth and fourteenth embodiments. The control device 20 controls the heat radiation controller, to reduce the heat radiation capability of the working fluid by the cold-heat heat exchanger 12 or the working-fluid heat exchanger 19. Thereby, the saturation temperature of the working fluid circulating in the thermosiphon circuit 10 is raised.

In step S12, when the control device 20 determines that the value obtained by subtracting the outside air temperature from the saturation temperature of the working fluid is equal to or higher than the lower limit temperature T-A, the control device 20 proceeds to step S13.

In step S13, the control device 20 determines whether the value obtained by subtracting the outside air temperature detected by the outside air temperature detector 16 from the saturation temperature of the working fluid detected by the saturation temperature detector 17 is larger than the upper limit temperature ΔT+B. When the control device 20 determines that the value obtained by subtracting the outside air temperature from the saturation temperature of the working fluid is larger than the upper limit temperature ΔT+B, the control device 20 proceeds to step S30.

The process in step S30 is the same as the process described in the fourteenth embodiment. The control device 20 controls the heat radiation controller to raise the heat radiation capability of the working fluid by the cold-heat heat exchanger 12 or the working-fluid heat exchanger 19. Thereby, the saturation temperature of the working fluid circulating in the thermosiphon circuit 10 is lowered.

In step S13, when the control device 20 determines that the value obtained by subtracting the outside air temperature from the saturation temperature of the working fluid is equal to or lower than the upper limit temperature ΔT+B, the control device 20 temporarily ends the processing. In this case, it can be said that the value obtained by subtracting the outside air temperature from the saturation temperature of the working fluid circulating in the thermosiphon circuit 10 is in the range between the upper limit temperature ΔT+B and the lower limit temperature ΔT−A. Then, after a lapse of the predetermined time, the control device 20 starts the process again from step S12. In this way, the equipment cooling device 1 of the thirteenth embodiment adjusts the heat radiation controller so that the value obtained by subtracting the outside air temperature from the saturation temperature of the working fluid circulating in the thermosiphon circuit 10 falls within a predetermined temperature range. The equipment cooling device 1 of the fifteenth embodiment described above can also achieve the same operation and effects as the thirteenth and fourteenth embodiments.

### Other Embodiments

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

(1) In the embodiments, the battery pack 2 mounted on a vehicle has been described as an example of a device to which the equipment cooling device 1 adjusts in the temperature. In another embodiment, the device to be cooled by the equipment cooling device 1 may be another device that needs cooling, such as a motor, an inverter, or a charger.

(2) In the embodiments, the function of the equipment cooling device 1 for cooling the target equipment has been described. In another embodiment, the equipment cooling device 1 may have a function of warming up the target equipment in addition to the cooling function.

(3) In the embodiments, a chlorofluorocarbon-based refrigerant is employed as the working fluid, but is not limited to this. As the working fluid, other fluids such as propane and carbon dioxide may be employed.

(4) In the embodiments, the heat radiation controller may be the compressor 31, the expansion valve 33, the condenser fan 321, the shutter 322 of the refrigeration cycle 30, the flow control valve 18 provided in the thermosiphon circuit 10, the pump 41 provided in the coolant circuit 40 and the like. In other embodiments, plural heat radiation controllers may be used in combination.

(5) In the embodiments, the control device 20 that controls the driving of the heat radiation controller is an electronic controller. In another embodiment, the control device 20 that controls the driving of the heat radiation controller may be configured mechanically or may be configured by an analog circuit.

### (Overview)

According to the first aspect described in part or all of the above-described embodiments, the equipment cooling device cools the target equipment by a thermosiphon circuit that uses cold heat of a refrigeration cycle and cold heat of outside air. The equipment cooling device includes a cooler, a cold-heat heat exchanger, an air-cooled heat exchanger, a gas pipe, a liquid pipe, an outside air temperature detector, a saturation temperature detector, and a heat radiation controller. The cooler cools the target equipment by the latent heat of evaporation of the working fluid. The cold-heat heat exchanger condenses the working fluid evaporated by the cooler using cold heat of a low-temperature and low-pressure refrigerant circulating in a refrigeration cycle. The air-cooled heat exchanger condenses the working fluid evaporated by the cooler by utilizing the cold heat of the outside air. The gas pipe guides the refrigerant evaporated in the cooler to the cold-heat heat exchanger and the air-cooled heat exchanger. The liquid pipe guides the refrigerant condensed by the cold-heat heat exchanger and the air-cooled heat exchanger to the cooler. The outside air temperature detector detects an outside air temperature. The saturation temperature detector detects a saturation temperature of working fluid circulating in a thermosiphon circuit including the cooler, the cold-heat heat exchanger, the air-cooled heat exchanger, the gas pipe, and the liquid pipe. The heat radiation controller adjusts the heat radiation amount of the working fluid flowing through the cold-heat heat exchanger so that the saturation temperature of the working fluid becomes higher than the outside air temperature.

According to the second aspect, the cold-heat heat exchanger comprises a heat exchanger configured to exchange heat between a low-temperature and low-pressure refrigerant circulating in a refrigeration cycle and a working fluid flowing through the cold-heat heat exchanger. According to this, the cold-heat heat exchanger can condense the working fluid by directly utilizing the cold heat of the low-temperature and low-pressure refrigerant circulating in the refrigeration cycle.

According to the third aspect, the equipment cooling device further includes a coolant circuit in which cooling water is circulated to be cooled by the low-temperature and low-pressure refrigerant circulating in the refrigeration cycle. The cold-heat heat exchanger is a heat exchanger configured to exchange heat between cooling water circulating in the coolant circuit and working fluid circulating in a thermosiphon circuit. According to this, the cooling water circulating through the coolant circuit is cooled by the cold heat of the low-temperature and low-pressure refrigerant circulating through the refrigeration cycle. The cold-heat heat exchanger condenses the working fluid by the cold heat of the cooling water circulating in the coolant circuit. Therefore, the refrigerant pipe of the refrigeration cycle can be shortened.

According to the fourth aspect, the equipment cooling device further includes a coolant circuit in which cooling water is circulated to be cooled by the low-temperature and low-pressure refrigerant circulating in the refrigeration cycle. The cold-heat heat exchanger is a heat exchanger configured to exchange heat between cooling water circulating in the coolant circuit and working fluid circulating in a thermosiphon circuit. The heat radiation controller is a pump that adjusts the flow rate of the cooling water circulating in the coolant circuit. According to this, the pump as the heat radiation controller can adjust the amount of cold heat supplied from the refrigeration cycle to the cold-heat heat exchanger by controlling the flow rate of the cooling water circulating in the coolant circuit.

According to the fifth aspect, the equipment cooling device is to be mounted on a vehicle. In the refrigeration cycle, an air-conditioning evaporator used as a cold heat supply source of an air conditioner that performs air-conditioning in the vehicle cabin and a cold-heat heat exchanger used to condense working fluid circulating in a thermosiphon circuit are connected in parallel. According to this, the equipment cooling device can use the refrigeration cycle for air-conditioning in the vehicle to condense the working fluid flowing through the cold-heat heat exchanger. Therefore, the equipment cooling device can reduce the number of components to simplify the configuration.

According to the sixth aspect, the equipment cooling device is to be mounted on a vehicle. In the refrigeration cycle, an air-conditioning evaporator used as a cold heat supply source of an air conditioner that performs air-conditioning in the vehicle cabin and a cold-heat heat exchanger used to condense working fluid circulating in a thermosiphon circuit are connected in parallel. The heat radiation controller is an equipment cooling expansion valve capable of adjusting the flow rate of the refrigerant flowing through the cold-heat heat exchanger. According to this, the equipment cooling device can control the amount of cold heat of the refrigeration cycle used for air-conditioning in the vehicle cabin and the amount of cold heat of the refrigeration cycle used for the cold-heat heat exchanger by the operation of the equipment cooling expansion valve.

According to the seventh aspect, the equipment cooling device is to be mounted on a vehicle. The equipment cooling device further includes a coolant circuit that circulates cooling water to be cooled by the low-temperature and low-pressure refrigerant that circulates through the refrigeration cycle. In the refrigeration cycle, an air-conditioning evaporator used as a cold heat supply source of an air conditioner for performing air-conditioning in a vehicle cabin and a water-refrigerant heat exchanger for cooling the cooling water circulating in a coolant circuit are connected in parallel. The heat radiation controller is an equipment cooling expansion valve that can adjust the flow rate of the refrigerant in the refrigeration cycle flowing through the water-refrigerant heat exchanger.

According to this, the cooling water circulating through the coolant circuit is cooled by the low-temperature and low-pressure refrigerant circulating through the refrigeration cycle in the water-refrigerant heat exchanger. The cold-heat heat exchanger condenses the working fluid by the cold heat of the cooling water circulating in the coolant circuit. The equipment cooling expansion valve as a heat radiation controller can adjust the amount of cold heat of the refrigeration cycle used for air-conditioning in the vehicle cabin and the amount of cold heat of the refrigeration cycle used for the cold-heat heat exchanger.

According to the eighth aspect, the cold-heat heat exchanger and the air-cooled heat exchanger are connected in parallel by a gas pipe and a liquid pipe. The heat radiation controller is a flow rate adjusting valve provided in the thermosiphon circuit to adjust the flow rate of the working fluid flowing through the cold-heat heat exchanger. According to this, the flow rate control valve as the heat radiation controller reduces the flow amount of the working fluid flowing through the cold-heat heat exchanger, so that the heat radiation amount of the working fluid by the cold-heat heat exchanger becomes small.

According to the ninth aspect, the heat radiation controller adjusts the heat radiation amount of the working fluid flowing through the cold-heat heat exchanger by adjusting the flow rate or the temperature of the refrigerant circulating in the refrigeration cycle. That is, the heat radiation controller adjusts the heat radiation amount of the working fluid flowing through the cold-heat heat exchanger to be small by reducing the flow rate of the refrigerant circulating in the refrigeration cycle or by increasing the temperature of the refrigerant.

According to the tenth aspect, the refrigeration cycle has a compressor, a refrigerant condenser, an expansion valve, and a refrigerant evaporator. The compressor compresses the refrigerant. The refrigerant condenser condenses the refrigerant compressed by the compressor by heat exchange with outside air. The expansion valve decompresses and expands the refrigerant flowing out of the refrigerant condenser. The refrigerant evaporator causes the refrigerant flowing out of the expansion valve to absorb heat of condensation of the working fluid to evaporate the refrigerant. The heat radiation controller reduces the rotation speed of the compressor, reduces the passage area of the expansion valve, or reduces the amount of air flowing through the refrigerant condenser, thereby reducing the working fluid flowing through the cold-heat heat exchanger. The adjustment is performed so that the amount of heat radiation is reduced. According to this, the flow rate of the refrigerant circulating in the refrigeration cycle decreases due to a decrease in the rotation speed of the compressor, a decrease in the passage area of the expansion valve, or a decrease in the amount of air passing through the refrigerant condenser. Thus, the temperature of the refrigerant is raised. Therefore, the heat radiation controller can reduce the heat radiation amount of the working fluid flowing through the cold-heat heat exchanger.

According to the eleventh aspect, the equipment cooling device cools a target equipment by a thermosiphon circuit that uses cold heat of a refrigeration cycle and cold heat of outside air. The equipment cooling device includes a cooler, a working-fluid heat exchanger, a gas pipe, a liquid pipe, a coolant circuit, an air radiator, a water-refrigerant heat exchanger, an outside air temperature detector, a cooling water temperature detector, and a heat radiation controller. The cooler cools the target equipment by the latent heat of evaporation of the working fluid. The working-fluid heat exchanger radiates heat of the working fluid evaporated by the cooler to condense the working fluid. The gas pipe guides the refrigerant evaporated in the cooler to the working-fluid heat exchanger. The liquid pipe guides the refrigerant condensed in the working-fluid heat exchanger to the cooler. In the coolant circuit, cooling water flows to exchange heat with the working fluid flowing through the working-fluid heat exchanger. The air radiator is provided in the coolant circuit, and performs heat exchange between cooling water circulating in the coolant circuit and outside air. The water-refrigerant heat exchanger is provided in the coolant circuit and exchanges heat between the cooling water circulating in the coolant circuit and the low-temperature and low-pressure refrigerant circulating in the refrigeration cycle. The outside air temperature detector detects an outside air temperature. The cooling water temperature detector detects the temperature of the cooling water circulating in the coolant circuit. The heat radiation controller adjusts the heat radiation amount of the cooling water flowing through the water-refrigerant heat exchanger so that the temperature of the cooling water circulating in the coolant circuit becomes higher than the outside air temperature.

According to this, the cooling water circulating in the coolant circuit is cooled by the air radiator using the cold heat of the outside air and the water-refrigerant heat exchanger using the cold heat of the low-temperature and low-pressure refrigerant circulating in the refrigeration cycle. The working-fluid heat exchanger condenses the working fluid by heat exchange between the working fluid and the cooling water cooled by the air radiator and the water-refrigerant heat exchanger. In such a configuration, the temperature of the cooling water circulating in the coolant circuit becomes higher than the outside air temperature due to the operation of the heat radiation controller. Thus, the cooling water circulating in the coolant circuit is cooled using both the cold heat of the low-temperature and low-pressure refrigerant circulating in the refrigeration cycle and the cold heat of the outside air. Therefore, the amount of cold heat of the refrigeration cycle used for cooling the cooling water can be reduced by the amount of the cold heat of the outside air used for cooling the cooling water circulating in the coolant circuit. Therefore, the equipment cooling device can reduce the amount of energy consumed by the refrigeration cycle to generate cold heat.

According to the twelfth aspect, an equipment cooling device includes a saturation temperature detector that detects a saturation temperature of a working fluid circulating in a thermosiphon circuit including a cooler, a working-fluid heat exchanger, a gas pipe, and a liquid pipe. The heat radiation controller adjusts the heat radiation amount of the working fluid flowing through the working-fluid heat exchanger so that the saturation temperature of the working fluid circulating in the thermosiphon circuit becomes higher than the outside air temperature. According to this, when the saturation temperature of the working fluid circulating in the thermosiphon circuit and the temperature of the cooling water circulating in the coolant circuit are both higher than the outside air temperature, the cooling water circulating in the coolant circuit is cooled by both of the water-refrigerant heat exchanger and the air radiator. Therefore, the amount of the cold heat of the refrigeration cycle used for condensing the working fluid by the working-fluid heat exchanger can be reduced by the amount of cold heat of the outside air used for condensing the working fluid by the working-fluid heat exchanger via the cooling water circulating in the coolant circuit. Therefore, the equipment cooling device can reduce the amount of energy consumed by the refrigeration cycle to generate cold heat.

According to the thirteenth aspect, the equipment cooling device is to be mounted on a vehicle. The refrigeration cycle is configured such that an air-conditioning evaporator used as a cold heat supply source of an air conditioner that performs air-conditioning in a vehicle cabin is connected with a water-refrigerant heat exchanger in parallel. The heat radiation controller is an equipment cooling expansion valve that can adjust the flow rate of the refrigerant in the refrigeration cycle flowing through the water-refrigerant heat exchanger. According to this, the equipment cooling device operates the equipment cooling expansion valve to reduce the amount of cold heat of the refrigeration cycle used for air-conditioning in the vehicle cabin and the amount of cold heat of the refrigeration cycle used for the water-refrigerant heat exchanger.

According to the fourteenth aspect, the equipment cooling device cools a target equipment by a thermosiphon circuit that uses cold heat of a refrigeration cycle and cold heat of outside air. The equipment cooling device includes a cooler, a working-fluid heat exchanger, a gas pipe, a liquid pipe, a coolant circuit, an air radiator, an outside air temperature detector, a saturation temperature detector, and a heat radiation controller. The cooler cools the target equipment by the latent heat of evaporation of the working fluid. The working-fluid heat exchanger radiates the heat of working fluid evaporated by the cooler to condense the working fluid. The gas pipe guides the refrigerant evaporated in the cooler to the working-fluid heat exchanger. The liquid pipe guides the refrigerant condensed in the working-fluid heat exchanger to the cooler. In the coolant circuit, cooling water flows to exchange heat with the working fluid flowing through the working-fluid heat exchanger. The air radiator is provided in the coolant circuit, and performs heat exchange between cooling water circulating in the coolant circuit and outside air. The outside air temperature detector detects an outside air temperature. The saturation temperature detector detects a saturation temperature of working fluid circulating in a thermosiphon circuit including the cooler, the working-fluid heat exchanger, the gas pipe, and the liquid pipe. The heat radiation controller adjusts the heat radiation amount of the working fluid flowing through the working-fluid heat exchanger so that the saturation temperature of the working fluid becomes higher than the outside air temperature. The working-fluid heat exchanger is configured to exchange heat between the working fluid flowing through the working-fluid heat exchanger, the low-temperature and low-pressure refrigerant circulating in the refrigeration cycle, and the cooling water circulating in the coolant circuit.

According to this, the cooling water circulating in the coolant circuit is cooled by the air radiator that uses the cold heat of the outside air. The working-fluid heat exchanger condenses the working fluid by heat exchange between the cooling water cooled by the air radiator, the low-temperature and low-pressure refrigerant circulating in the refrigeration cycle, and the working fluid. Therefore, the working-fluid heat exchanger can condense the working fluid using both the cold heat of the low-temperature and low-pressure refrigerant circulating in the refrigeration cycle and the cold heat of the outside air. In such a configuration, when the saturation temperature of the working fluid becomes higher than the outside air temperature due to the operation of the heat radiation controller, the working-fluid heat exchanger can condense the working fluid by utilizing both the cold heat of the low-temperature and low-pressure refrigerant circulating in the refrigeration cycle and the cold heat of the outside air. Therefore, the amount of cold energy of the refrigeration cycle used for condensing the working fluid by the working-fluid heat exchanger can be reduced by the amount of the cold heat of the outside air used for condensing the working fluid by the working-fluid heat exchanger. Therefore, the equipment cooling device can reduce the amount of energy consumed by the refrigeration cycle to generate cold heat.

According to the fifteenth aspect, the equipment cooling device is to be mounted on a vehicle. The refrigeration cycle is configured such that an air-conditioning evaporator used as a cold heat supply source of an air conditioner that performs air-conditioning in a vehicle cabin and a working-fluid heat exchanger are connected in parallel. The heat radiation controller is an equipment cooling expansion valve that adjusts the amount of heat radiation of the working fluid by the working-fluid heat exchanger to be small by reducing the flow rate of the refrigerant in the refrigeration cycle flowing through the working-fluid heat exchanger. According to this, the equipment cooling device adjusts the amount of cold heat of the refrigeration cycle used for air-conditioning in the vehicle cabin and the amount of cold heat of the refrigeration cycle used for the working-fluid heat exchanger by operating the equipment cooling expansion valve.

According to the sixteenth aspect, the heat radiation controller adjusts the heat radiation amount of the working fluid flowing through the working-fluid heat exchanger by adjusting the flow rate or the temperature of the refrigerant circulating in the refrigeration cycle. According to this, the heat radiation controller reduces the heat radiation amount of the working fluid flowing through the working-fluid heat exchanger by reducing the flow rate of the refrigerant circulating in the refrigeration cycle or increasing the temperature of the refrigerant.

According to the seventeenth aspect, a refrigeration cycle has a compressor, a refrigerant condenser, an expansion valve, and a refrigerant evaporator. The compressor compresses the refrigerant. The refrigerant condenser condenses the refrigerant compressed by the compressor by heat exchange with the outside air. The expansion valve decompresses and expands the refrigerant flowing out of the refrigerant condenser. The refrigerant evaporator causes the refrigerant flowing out of the expansion valve to absorb heat of condensation of the working fluid to evaporate the refrigerant. The heat radiation controller reduces the heat radiation amount of the working fluid flowing through the working-fluid heat exchanger by reducing the rotation speed of the compressor, reducing the passage area of the expansion valve, or reducing the amount of air flowing through the refrigerant condenser. According to this, the flow rate of the refrigerant circulating in the refrigeration cycle decreases due to a decrease in the rotation speed of the compressor, a decrease in the passage area of the expansion valve, or a decrease in the amount of air passing through the refrigerant condenser. Thus, the temperature of the refrigerant is raised. Therefore, the heat radiation controller can reduce the heat radiation amount of the working fluid flowing through the working-fluid heat exchanger.

According to the eighteenth aspect, the equipment cooling device further includes a control device that controls the heat radiation controller. The control device selects and executes the power-saving cooling mode or the quick cooling mode. When executing the power-saving cooling mode, the control device controls the heat radiation controller to make the saturation temperature of the working fluid higher than the outside air temperature. Further, when executing the quick cooling mode, the controller controls the heat radiation controller to control the saturation temperature of the working fluid to be lower than the outside air temperature. According to this, in the power-saving cooling mode, it is possible to condense the working fluid using both the cold heat of the low-temperature and low-pressure refrigerant circulating in the refrigeration cycle and the cold heat of the outside air. Therefore, the amount of energy consumed by the refrigeration cycle to generate cold heat can be reduced. On the other hand, in the quick cooling mode, since the saturation temperature of the working fluid is lower than the outside air temperature, the cooler can rapidly cool the target equipment by the latent heat of vaporization of the working fluid.

According to the nineteenth aspect, a predetermined first threshold and a predetermined second threshold lower than the first threshold are set in the control device. When the temperature of the target equipment is higher than the first threshold, the control device executes the quick cooling mode until the temperature of the target equipment becomes equal to or lower than the second threshold. On the other hand, when the quick cooling mode is not being executed and the temperature of the target equipment is lower than the first threshold, the control device executes the power-saving cooling mode. According to this, when the temperature of the target equipment is higher than the first threshold, the controller can rapidly cool the target equipment by executing the quick cooling mode. On the other hand, when the quick cooling mode is not executed and the temperature of the target equipment is lower than the first threshold, the controller executes the power-saving cooling mode to reduce the energy consumption consumed by the refrigeration cycle to produce cold heat.

According to the twentieth aspect, the equipment cooling device further includes a control device that controls the heat radiation controller. The control device controls the heat radiation controller such that a value obtained by subtracting the outside air temperature from the saturation temperature of the working fluid is equal to or higher than a predetermined temperature. According to this, the cold energy of the outside air is reliably used for condensing the working fluid by the air-cooled heat exchanger or the working-fluid heat exchanger. Therefore, the cold-heat heat exchanger or the working-fluid heat exchanger can reduce the amount of cold heat of the refrigeration cycle used for condensing the working fluid by the amount of the cold heat of the outside air used for condensing the working fluid. Therefore, the equipment cooling device can reduce the amount of energy consumed by the refrigeration cycle to generate cold heat.

According to the twenty-first aspect, the target equipment to be cooled by the cooler is a battery pack that is mounted on an electric vehicle to store power for driving a vehicle driving motor. The electric power stored in the battery pack is consumed by the refrigeration cycle to generate cold heat. Therefore, the equipment cooling device can suppress the discharge amount of the battery pack by reducing the amount of energy consumed by the refrigeration cycle to generate cold heat. Therefore, the equipment cooling device can increase the traveling distance of the electric vehicle by the vehicle traveling motor.

What is claimed is:

1. An equipment cooling device configured to cool a target equipment by a thermosiphon circuit that uses cold heat of a refrigeration cycle and cold heat of outside air, the equipment cooling device comprising:
a cooler configured to cool the target equipment by evaporation latent heat of working fluid;
a cold-heat heat exchanger configured to condense the working fluid by radiating heat of the working fluid evaporated in the cooler by utilizing cold heat of low-temperature and low-pressure refrigerant circulating in the refrigeration cycle;
an air-cooled heat exchanger configured to condense the working fluid by radiating heat of the working fluid evaporated in the cooler by utilizing cold heat of outside air;
a gas pipe to guide the working fluid evaporated by the cooler to the cold-heat heat exchanger and the air-cooled heat exchanger;
a liquid pipe to guide the working fluid condensed in the cold-heat heat exchanger and the air-cooled heat exchanger to the cooler;
an outside air temperature detector configured to detect an outside air temperature;
a saturation temperature detector configured to detect a saturation temperature of working fluid circulating through the thermosiphon circuit that includes the cooler, the cold-heat heat exchanger, the air-cooled heat exchanger, the gas pipe and the liquid pipe; and
a heat radiation controller configured to control a heat radiation amount of the working fluid flowing through the cold-heat heat exchanger such that the saturation temperature of the working fluid becomes higher than the temperature of outside air.

2. The equipment cooling device according to claim 1, wherein
the cold-heat heat exchanger is configured to exchange heat between low-temperature and low-pressure refrigerant circulating in the refrigeration cycle and working fluid flowing through the cold-heat heat exchanger.

3. The equipment cooling device according to claim 1, further comprising: a coolant circuit for circulating cooling water cooled by cold heat of low-temperature and low-pressure refrigerant circulating in the refrigeration cycle, wherein
the cold-heat heat exchanger is configured to exchange heat between the cooling water circulating through the coolant circuit and the working fluid circulating through the thermosiphon circuit.

4. The equipment cooling device according to claim 1, further comprising: a coolant circuit for circulating cooling water cooled by cold heat of low-temperature and low-pressure refrigerant circulating in the refrigeration cycle, wherein
the cold-heat heat exchanger is configured to exchange heat between the cooling water circulating through the coolant circuit and the working fluid circulating through the thermosiphon circuit, and
the heat radiation controller is a pump that controls a flow rate of cooling water circulating in the coolant circuit.

5. The equipment cooling device according to claim 1 which is to be mounted on a vehicle, wherein the refrigeration cycle includes an air-conditioning evaporator used as a cold heat supply source of an air conditioner that performs air-conditioning in a vehicle cabin, and
the cold-heat heat exchanger is connected in parallel with the air-conditioning evaporator for condensing the working fluid circulating in the thermosiphon circuit.

6. The equipment cooling device according to claim 1 which is to be mounted on a vehicle, wherein the refrigeration cycle includes an air-conditioning evaporator used as a cold heat supply source of an air conditioner that performs air-conditioning in a vehicle cabin,
the cold-heat heat exchange is connected in parallel with the air-conditioning evaporator for condensing the working fluid circulating in the thermosiphon circuit, and
the heat radiation controller is an equipment cooling expansion valve capable of controlling a flow rate of refrigerant flowing through the cold-heat heat exchanger.

7. The equipment cooling device according to claim 3 which is to be mounted on a vehicle, further comprising:
a coolant circuit for circulating cooling water cooled by the low-temperature and low-pressure refrigerant circulating in the refrigeration cycle, wherein
the refrigeration cycle includes an air-conditioning evaporator used as a cold heat supply source of an air conditioner for performing air-conditioning in a vehicle cabin, and a water-refrigerant heat exchanger in which the cooling water circulating in the coolant circuit is cooled,
the air-conditioning evaporator and the water-refrigerant heat exchanger are connected in parallel, and
the heat radiation controller is an equipment cooling expansion valve capable of controlling a flow rate of refrigerant of the refrigeration cycle flowing through the water-refrigerant heat exchanger.

8. The equipment cooling device according to claim 1, wherein
the cold-heat heat exchanger and the air-cooled heat exchanger are connected in parallel by the gas pipe and the liquid pipe, and
the heat radiation controller is a flow control valve provided in the thermosiphon circuit and being capable of controlling a flow rate of working fluid flowing through the cold-heat heat exchanger.

9. The equipment cooling device according to claim 1, wherein
the heat radiation controller controls a flow rate or temperature of refrigerant circulating in the refrigeration cycle to control the heat radiation amount of working fluid flowing through the cold-heat heat exchanger.

10. The equipment cooling device according to claim 1, wherein the refrigeration cycle includes:
a compressor for compressing the refrigerant;
a refrigerant condenser for condensing the refrigerant compressed by the compressor by heat exchange with outside air;
an expansion valve for decompressing and expanding the refrigerant flowing out of the refrigerant condenser; and
a refrigerant evaporator for causing the refrigerant flowing out of the expansion valve to absorb heat of condensation of the working fluid to evaporate the refrigerant, and
the heat radiation controller is configured to reduce the heat radiation amount of the working fluid flowing through the cold-heat heat exchanger by decreasing a rotation speed of the compressor, a passage area of the expansion valve, or an amount of air passing through the refrigerant condenser.

11. An equipment cooling device configured to cool a target equipment by a thermosiphon circuit that uses cold energy of a refrigeration cycle and cold energy of outside air, the equipment cooling device comprising:
a cooler configured to cool the target equipment by evaporation latent heat of working fluid;
a working-fluid heat exchanger configured to condense the working fluid by radiating heat of the working fluid evaporated in the cooler;
a gas pipe to guide the working fluid evaporated in the cooler to the working-fluid heat exchanger;
a liquid pipe to guide the working fluid condensed in the working-fluid heat exchanger to the cooler;
a coolant circuit through which cooling water flows to exchange heat with the working fluid flowing through the working-fluid heat exchanger;
an air radiator provided in the coolant circuit to exchange heat between the cooling water circulating in the coolant circuit and outside air;
a water-refrigerant heat exchanger provided in the coolant circuit to exchange heat between the cooling water circulating in the coolant circuit and low-temperature and low-pressure refrigerant circulating in the refrigeration cycle;
an outside air temperature detector to detect an outside air temperature;
a cooling water temperature detector to detect a temperature of the cooling water circulating in the coolant circuit; and
a heat radiation controller configured to control a heat radiation amount of the cooling water flowing through the water-refrigerant heat exchanger such that the temperature of the cooling water circulating in the coolant circuit becomes higher than the outside air temperature.

12. The equipment cooling device according to claim 11, further comprising:
a saturation temperature detector to detect a saturation temperature of working fluid circulating in the thermosiphon circuit that includes the cooler, the working-fluid heat exchanger, the gas pipe, and the liquid pipe, wherein
the heat radiation controller controls a heat radiation amount of the working fluid flowing through the working-fluid heat exchanger such that the saturation temperature of the working fluid circulating in the thermosiphon circuit is higher than the outside air temperature.

13. The equipment cooling device according to claim 11 which is to be mounted on a vehicle, wherein
the refrigeration cycle includes an air-conditioning evaporator used as a cold heat supply source of an air conditioner for performing air-conditioning in a vehicle cabin,
the air-conditioning evaporator and the water-refrigerant heat exchanger are connected in parallel, and
the heat radiation controller is an equipment cooling expansion valve capable of controlling a flow rate of refrigerant of the refrigeration cycle flowing through the water-refrigerant heat exchanger.

14. An equipment cooling device configured to cool a target equipment by a thermosiphon circuit that uses cold energy of a refrigeration cycle and cold energy of outside air, the equipment cooling device comprising:
a cooler configured to cool the target equipment by evaporation latent heat of working fluid;
a working-fluid heat exchanger configured to condense the working fluid by radiating heat of the working fluid evaporated in the cooler;
a gas pipe to guide the working fluid evaporated in the cooler to the working-fluid heat exchanger;
a liquid pipe to guide the working fluid condensed in the working-fluid heat exchanger to the cooler;
a coolant circuit through which cooling water flows to exchange heat with the working fluid flowing through the working-fluid heat exchanger;
an air radiator provided in the coolant circuit to exchange heat between the cooling water circulating in the coolant circuit and outside air;
an outside air temperature detector to detect an outside air temperature;
a saturation temperature detector to detect a saturation temperature of working fluid circulating through the thermosiphon circuit that includes the cooler, the working-fluid heat exchanger, the gas pipe, and the liquid pipe; and
a heat radiation controller configured to control a heat radiation amount of the working fluid flowing through the working-fluid heat exchanger such that the saturation temperature of the working fluid becomes higher than the outside air temperature, wherein
the working-fluid heat exchanger is configured to exchange heat among the working fluid flowing through the working-fluid heat exchanger, the low-temperature and low-pressure refrigerant circulating in the refrigeration cycle, and the cooling water circulating in the coolant circuit.

15. The equipment cooling device according to claim 14 which is to be mounted on a vehicle, wherein
the refrigeration cycle includes an air-conditioning evaporator used as a cold heat supply source of an air conditioner that performs air-conditioning in a vehicle cabin,
the air-conditioning evaporator and the working-fluid heat exchanger are connected in parallel, and
the heat radiation controller is an equipment cooling expansion valve that reduces a flow rate of the refrigerant of the refrigeration cycle flowing through the working-fluid heat exchanger to decrease the heat radiation amount of working fluid by the working-fluid heat exchanger.

16. The equipment cooling device according to claim 14, wherein the heat radiation controller is configured to control a flow rate or temperature of refrigerant circulating in the refrigeration cycle to control the heat radiation amount of working fluid flowing through the working-fluid heat exchanger.

17. The equipment cooling device according to claim 14, wherein the refrigeration cycle includes:
a compressor for compressing the refrigerant;
a refrigerant condenser for condensing the refrigerant compressed by the compressor by heat exchange with outside air;
an expansion valve for decompressing and expanding the refrigerant flowing out of the refrigerant condenser; and
a refrigerant evaporator for causing the refrigerant flowing out of the expansion valve to absorb heat of condensation of the working fluid to evaporate the refrigerant, and
the heat radiation controller reduces the heat radiation amount of the working fluid flowing in the working-fluid heat exchanger by decreasing a rotation speed of the compressor, a passage area of the expansion valve, or an amount of air passing through the refrigerant condenser.

18. The equipment cooling device according to claim 14, further comprising: a control device to control the heat radiation controller, the control device is configured to select and execute a power-saving cooling mode by controlling the heat radiation controller to make the saturation temperature of the working fluid higher than the outside air temperature, or a quick cooling mode by controlling the heat radiation controller to make the saturation temperature of the working fluid lower than the outside air temperature.

19. The equipment cooling device according to claim 18, wherein
the control device sets a predetermined first threshold and a predetermined second threshold lower than the first threshold,
when the temperature of the target equipment is higher than the first threshold, the control device executes the quick cooling mode until the temperature of the target equipment becomes equal to or lower than the second threshold, and
the control device executes the power-saving cooling mode when the quick cooling mode is not executed and the temperature of the target equipment is lower than the first threshold.

20. The equipment cooling device according to claim 14, further comprising: a control device to control the heat radiation controller, wherein
the control device controls the heat radiation controller such that a value obtained by subtracting the outside air temperature from the saturation temperature of the working fluid is equal to or higher than a predetermined temperature.

21. The equipment cooling device according to claim 1, wherein the target equipment cooled by the cooler is a battery pack that is mounted on an electric vehicle to store electric power for driving a motor of the vehicle.
